(19) United States
(12) Patent Application Publication
(10) Pub. No.: US 2023/0204769 A1
(43) Pub. Date: Jun. 29, 2023

(54) RANGING DEVICE, ELECTRONIC DEVICE, SENSOR SYSTEM, AND CONTROL METHOD

(71) Applicant: SONY SEMICONDUCTOR SOLUTIONS CORPORATION, KANAGAWA (JP)

(72) Inventor: SHOJI SETA, KANAGAWA (JP)

(21) Appl. No.: 17/999,407

(22) PCT Filed: May 28, 2021
(86) PCT No.: PCT/JP2021/020360

§ 371 Date: Nov. 21, 2022

(30) Foreign Application Priority Data
Jun. 4, 2020 (JP) 2020-098009

(51) Int. Cl. G01S 17/08; G01S 7/481

(52) U.S. Cl. CPC G01S 17/08; G01S 7/4816

(57) ABSTRACT

Accurate information is acquired even in a case where a sensor is deteriorated. A ranging device according to an embodiment includes: a sensor (11) that acquires ranging information; a field-programmable gate array (FPGA) (131) that executes predetermined processing on the ranging information acquired by the sensor; and a memory (15) that stores data for causing the FPGA to execute the predetermined processing.

### FIELD

The present disclosure relates to a ranging device, an electronic device, a sensor system, and a control method.

### BACKGROUND

In recent years, with diffusion of the Internet of Things (IoT) into the society, development of systems has become active in which “things” such as sensors or devices are connected to a cloud, fog, a server, or the like through the Internet to exchange information with each other and the “things” control each other. In addition, development of systems for providing various services to users by utilizing big data collected by the IoT have been actively performed.

### CITATION LIST

### Patent Literatures

Patent Literature 1: JP 2000-235644 A
Patent Literature 2: JP 2018-26682 A

### SUMMARY

### Technical Problem

However, without being limited only the IoT, in a case where information is acquired using a sensor such as a camera, there is a problem that accurate information cannot be collected due to deterioration of the sensor itself due to use, aging, or others.

Therefore, the present disclosure proposes a ranging device, an electronic device, a sensor system, and a control method that make it possible to acquire accurate information even in a case where a sensor is deteriorated.

### Solution to Problem

To solve the problems described above, a ranging device according to an embodiment of the present disclosure includes: a sensor that acquires ranging information; a field-programmable gate array (FPGA) that executes predetermined processing on the ranging information acquired by the sensor; and a memory that stores data for causing the FPGA to execute the predetermined processing.

### BRIEF DESCRIPTION OF DRAWINGS

FIG. 1 is a schematic diagram illustrating a schematic configuration example of a sensor system according to a first embodiment.

FIG. 2 is a block diagram illustrating a schematic configuration example of a ranging sensor in a communication device as an electronic device according to the first embodiment.

FIG. 3 is a schematic diagram illustrating a stack configuration example of a sensor chip according to the first embodiment.

FIG. 4 is a diagram illustrating an exemplary case where an FPGA and a logic circuit according to the first embodiment are built in separate areas.

FIG. 5 is a diagram illustrating a case where FPGAs are built in parts of a logic circuit according to the first embodiment.

FIG. 6 is a schematic diagram illustrating another stack configuration example of the sensor chip according to the first embodiment.

FIG. 7 is a schematic diagram illustrating a stack configuration according to a first modification of the sensor chip according to the first embodiment.

FIG. 8 is a schematic diagram illustrating a stack configuration according to a second modification of the sensor chip according to the first embodiment.

FIG. 9 is a schematic diagram illustrating a stack configuration according to a third modification of the sensor chip according to the first embodiment.

FIG. 10 is a schematic diagram illustrating a stack configuration according to a fourth modification of the sensor chip according to the first embodiment.

FIG. 11 is a schematic diagram illustrating a stack configuration according to a fifth modification of the sensor chip according to the first embodiment.

FIG. 12 is a schematic diagram illustrating a stack configuration according to a sixth modification of the sensor chip according to the first embodiment.

FIG. 13 is a schematic diagram illustrating a stack configuration according to a seventh modification of the sensor chip according to the first embodiment.

FIG. 14 is a schematic diagram illustrating a stack configuration according to an eighth modification of the sensor chip according to the first embodiment.

FIG. 15 is a schematic diagram illustrating a stack configuration according to a ninth modification of the sensor chip according to the first embodiment.

FIG. 16 is a schematic diagram illustrating a stack configuration according to a tenth modification of the sensor chip according to the first embodiment.

FIG. 17 is a schematic diagram illustrating a stack configuration according to an eleventh modification of the sensor chip according to the first embodiment.

FIG. 18 is a schematic diagram illustrating a stack configuration according to a twelfth modification of the sensor chip according to the first embodiment.

FIG. 19 is a side view of the ranging sensor according to the first embodiment.

FIG. 20 is a waveform diagram illustrating a drive example of one cycle of pixels in the ranging sensor according to the first embodiment.

FIG. 21 is a flowchart illustrating an operation example of the ranging sensor according to the first embodiment.

FIG. 22 is a flowchart illustrating a schematic operation example of the communication device according to the first embodiment.

FIG. 23 is a flowchart illustrating a schematic operation example of a server according to the first embodiment.

FIG. 24 is a table illustrating examples of the cause of deterioration of a ranging sensor.

FIG. 25 is a block diagram illustrating a conventional device configuration.

FIG. 26 is a diagram for describing a flow performed when data is processed with the device configuration exemplified in FIG. 25.

FIG. 27 is a diagram illustrating the number of clock cycles required to process 1000 pieces of data in the device configuration exemplified in FIG. 25.

FIG. 28 is a block diagram illustrating a device configuration of the ranging sensor according to the first embodiment.

FIG. 29 is a diagram for explaining a flow when the ranging sensor according to the first embodiment processes data.

FIG. 30 is a diagram illustrating the number of clock cycles required when the ranging sensor according to the first embodiment processes 1000 pieces of data.

FIG. 31 is a block diagram illustrating a schematic configuration example of a ranging sensor according to a second embodiment.

FIG. 32 is a block diagram illustrating a schematic configuration example of a ranging sensor according to a third embodiment.

FIG. 33 is a schematic diagram illustrating a stack configuration according to a first modification of a sensor chip according to the third embodiment.

FIG. 34 is a schematic diagram illustrating a stack configuration according to a second modification of the sensor chip according to the third embodiment.

FIG. 35 is a schematic diagram illustrating a stack configuration according to a third modification of the sensor chip according to the third embodiment.

FIG. 36 is a schematic diagram illustrating a stack configuration according to a fourth modification of the sensor chip according to the third embodiment.

FIG. 37 is a schematic diagram illustrating a stack configuration according to a fifth modification of the sensor chip according to the third embodiment.

FIG. 38 is a schematic diagram illustrating a stack configuration according to a sixth modification of the sensor chip according to the third embodiment.

FIG. 39 is a schematic diagram illustrating a stack configuration according to a seventh modification of the sensor chip according to the third embodiment.

FIG. 40 is a schematic diagram illustrating a stack configuration according to an eighth modification of the sensor chip according to the third embodiment.

FIG. 41 is a schematic diagram illustrating a stack configuration according to a ninth modification of the sensor chip according to the second embodiment.

FIG. 42 is a schematic diagram illustrating a stack configuration according to a tenth modification of the sensor chip according to the third embodiment.

FIG. 43 is a schematic diagram illustrating a stack configuration according to an eleventh modification of the sensor chip according to the third embodiment.

FIG. 44 is a schematic diagram illustrating a stack configuration according to a twelfth modification of the sensor chip according to the third embodiment.

FIG. 45 is a diagram for explaining an example of DNN/CNN analysis processing (machine learning processing) according to the third embodiment.

FIG. 46 is a flowchart illustrating a schematic example of the operation according to the third embodiment.

FIG. 47 is a block diagram illustrating a schematic configuration example of a ranging sensor according to a fourth embodiment.

FIG. 48 is a schematic diagram illustrating a stack configuration according to a first modification of a sensor chip according to the fourth embodiment.

FIG. 49 is a schematic diagram illustrating a stack configuration according to a second modification of the sensor chip according to the fourth embodiment.

FIG. 50 is a schematic diagram illustrating a stack configuration according to a third modification of the sensor chip according to the fourth embodiment.

FIG. 51 is a schematic diagram illustrating a stack configuration according to a fourth modification of the sensor chip according to the fourth embodiment.

FIG. 52 is a schematic diagram illustrating a stack configuration according to a fifth modification of the sensor chip according to the fourth embodiment.

FIG. 53 is a schematic diagram illustrating a stack configuration according to a sixth modification of the sensor chip according to the fourth embodiment.

FIG. 54 is a schematic diagram illustrating a stack configuration according to a seventh modification of the sensor chip according to the fourth embodiment.

FIG. 55 is a schematic diagram illustrating a stack configuration according to an eighth modification of the sensor chip according to the fourth embodiment.

FIG. 56 is a schematic diagram illustrating a stack configuration according to a ninth modification of the sensor chip according to the fourth embodiment.

FIG. 57 is a schematic diagram illustrating a stack configuration according to a tenth modification of the sensor chip according to the fourth embodiment.

FIG. 58 is a schematic diagram illustrating a stack configuration according to an eleventh modification of the sensor chip according to the fourth embodiment.

FIG. 59 is a schematic diagram illustrating a stack configuration according to a twelfth modification of the sensor chip according to the fourth embodiment.

FIG. 60 is a schematic diagram illustrating a schematic configuration example of sensor systems according to the first and second embodiments.

FIG. 61 is a schematic diagram illustrating a schematic configuration example of sensor systems according to the third and fourth embodiments.

FIG. 62 is a schematic diagram illustrating a schematic configuration example of a sensor system according to a fifth embodiment.

FIG. 63 is a diagram illustrating use cases in which the sensor systems according to the first to fifth embodiments are applied to an ICM and use cases in which the sensor systems are applied to FA.

FIG. 64 is a diagram for describing a case where the sensor systems according to the first to fifth embodiments are applied to an ICM (part 1).

FIG. 65 is a diagram for describing a case where the sensor systems according to the first to fifth embodiments are applied to an ICM (part 2).

FIG. 66 is a diagram for describing a case where the sensor systems according to the first to fifth embodiments are applied to an ICM (part 3).

FIG. 67 is a diagram for describing a case where the sensor systems according to the first to fifth embodiments are applied to an ICM (part 4).

FIG. 68 is a diagram for describing a case where the sensor systems according to the first to fifth embodiments are applied to an ICM (part 5).

FIG. 69 is a diagram for describing a case where the sensor systems according to the first to fifth embodiments are applied to an ICM (part 6).

FIG. 70 is a table for describing a case where the sensor systems according to the first to fifth embodiments are applied to an ICM (part 7).

FIG. 71 is a diagram for describing use case 1 of the ICM illustrated in FIG. 63 (part 1).

FIG. 72 is a diagram for describing use case 1 of the ICM illustrated in FIG. 63 (part 2).

FIG. 73 is a diagram for describing a use case 2 of the ICM illustrated in FIG. 63.

FIG. 74 is a diagram for describing use case 3 of the ICM illustrated in FIG. 63 (part 1).

FIG. 75 is a diagram for describing use case 3 of the ICM illustrated in FIG. 63 (part 2).

FIG. 76 is a diagram for describing use case 3 of the ICM illustrated in FIG. 63 (part 3).

FIG. 77 is a diagram for describing a use case 5 of the ICM illustrated in FIG. 63 (part 1).

FIG. 78 is a diagram for describing a use case 5 of the ICM illustrated in FIG. 63 (part 2).

FIG. 79 is a diagram for describing use case 5 of the ICM illustrated in FIG. 63 (part 3).

FIG. 80 is a diagram for describing use case 5 of the ICM illustrated in FIG. 63 (part 4).

FIG. 81 is a diagram for describing use case 6 of the ICM illustrated in FIG. 63 (part 1).

FIG. 82 is a diagram for explaining use case 6 of the ICM illustrated in FIG. 63 (part 2).

FIG. 83 is a diagram for describing use case 6 of the ICM illustrated in FIG. 63 (part 3).

FIG. 84 is a diagram for describing use case 7 of the ICM illustrated in FIG. 63 (part 1).

FIG. 85 is a diagram for describing use case 7 of the ICM illustrated in FIG. 63 (part 2).

FIG. 86 is a graph for describing a case where the sensor systems according to the first to fifth embodiments are applied to FA (part 1).

FIG. 87 is a graph for describing a case where the sensor systems according to the first to fifth embodiments are applied to FA (part 2).

FIG. 88 is a diagram for describing use case 5 of FA illustrated in FIG. 63 (part 1).

FIG. 89 is a diagram for describing use case 5 of FA illustrated in FIG. 63 (part 2).

FIG. 90 is a diagram for describing use case 5 of FA illustrated in FIG. 63 (Part 3).

FIG. 91 is a diagram for describing use case 6 of FA illustrated in FIG. 63 (part 1).

FIG. 92 is a diagram for describing use case 6 of FA illustrated in FIG. 63 (part 2).

FIG. 93 is a diagram for describing use case 6 of FA illustrated in FIG. 63 (part 2).

FIG. 94 is a diagram for describing use case 7 of FA illustrated in FIG. 63.

FIG. 95 is a block diagram depicting an example of schematic configuration of a vehicle control system.

FIG. 96 is a diagram of assistance in explaining an example of installation positions of an outside-vehicle information detecting section and an imaging section.

### DESCRIPTION OF EMBODIMENTS

Hereinafter, an embodiment of the present disclosure will be described in detail on the basis of the drawings. Note that in the following embodiment, the same parts are denoted by the same symbols, and redundant description will be omitted.

In addition, the present disclosure will be described in the following order of items.

1. Introduction

2. First Embodiment

2.1 System Configuration

2.2 Device Configuration

2.3 Example of Stack Configuration of Sensor Chip

2.4 Another Specific Example of Stack Configuration

2.4.1 First Modification

2.4.2 Second Modification

2.4.3 Third Modification

2.4.4 Fourth Modification

2.4.5 Fifth Modification

2.4.6 Sixth Modification

2.4.7 Seventh Modification

2.4.8 Eighth Modification

2.4.9 Ninth Modification

2.4.10 Tenth Modification

2.4.11 Eleventh Modification

2.4.12 Twelfth Modification

2.5 Operation Example of Sensing

2.6 Relationship Between Each Piece of Processing and Chip

2.7 Deterioration Correction of Ranging Sensor 100

2.8 Procedure of Deterioration Correction

2.9 Analysis of Depth Performance (machine learning)

2.10 Operation Flow

2.10.1 Operation Example of Communication Device 2

2.10.2 Operation Example of Server 3

2.11 Deterioration Factor of Ranging Sensor 100

2.12 High-Speed Processing Method

2.13 Action and Effects

3. Second Embodiment

3.1 Device Configuration

3.2 Action and Effects

4. Third Embodiment

4.1 Device Configuration

4.2 Example of Stack Configuration of Sensor Chip

4.3 DNN/CNN Analysis Process

4.4 Correction Process

4.5 Action and Effects

5. Fourth Embodiment

5.1 Device Configuration

5.2 Stack Configuration Example of Sensor Chip

5.3 Action and Effects

6. Fifth Embodiment

7. Use Cases

7.1 In-Cabin Monitoring System (ICM) Use Cases

7.1.1 Use Case 1

7.1.2 Use Case 2

7.1.3 Use Case 3

7.1.4 Use Case 5

7.1.5 Use Case 6

7.1.6 Use Case 7

7.2 Use Case of FA

7.2.1 Use Case 1

7.2.2 Use Case 2

7.2.3 Use Case 3

7.2.4 Use Case 4

7.2.5 Use Case 5

7.2.6 Use Case 6

7.2.7 Use Case 7

8. Application Example

### 1. Introduction

Currently, as devices mounted with a sensor such as a camera module or a ranging sensor 100, for example, there are various devices such as a wearable terminal such as a smartphone or a mobile phone, a fixed device such as a fixed point camera or a monitoring camera, a travelling device such as a drone, an automobile, a home robot, a factory automation (FA) robot, a monitoring robot, or an autonomous robot, and a medical device. However, in these devices, aging deterioration of the sensor occurs as use frequency or use years increase. For example, the following items can be listed as examples as problems that occur in a case where the ranging sensor 100 is deteriorated over time.

Firstly, in a case where ranging information is acquired by an indirect time-of-flight (TOF) sensor module, the sensor module itself is deteriorated due to long-hours operation, aging, or others, whereby accurate depth performance (depth noise, depth error, reliability, and others) cannot be collected. In order to solve such a problem, it is necessary to replace with a new part or to perform recalibration to perform adjustment, which causes a problem that it takes a long time or a lot of trouble to solve the problem. Furthermore, in a case where the depth performance deteriorates due to aging deterioration, there occurs a problem that the safety may be impaired in a device that requires the depth performance in real time, for example, a travelling device such as a drone, an automobile, or a factory automation (FA) robot.

Secondly, in travelling devices or the like that requires real-time processing, such as a drone, an automobile, a home robot, a factory automation (FA) robot, a monitoring robot, or an autonomous robot, with an information processing device such as a microprocessor (MPU) or a graphics processing unit (GPU) performing conventional arithmetic processing, a complicated program can be flexibly executed. However, since the conventional arithmetic processing has a mechanism for sharing a memory 15 among arithmetic units, there is a problem that the processing time is redundant when interrupt processing is performed. In addition, due to the increased circuit scale, complication of processing such as machine learning, and others, there are problems such as an increase in power consumption and occurrence of heat problems (that is, safety problem). Furthermore, in a case where the real-time processing is performed, it is necessary to control a sensor module using an external image signal processor (ISP), an application processor (APP), a GPU, or the like, and thus the device becomes large. As a result, there occurs a problem that the cost, the system area, the weight, and the like increase and that downsizing of the device becomes difficult.

Thirdly, a general ranging sensor 100 outputs ranging information by calculating raw data acquired by a sensor module with a subsequent integrated circuit (IC) on which dedicated software is ported. However, since it is necessary to match drivers and porting in consideration of the version of the software and the like when the subsequent IC is changed, there is also a problem that the number of work steps generated at the time of changing the device configuration increases.

Therefore, in the following embodiments, a ranging device, an electronic device, a sensor system, and a control method that makes it possible to acquire accurate information even in a case where a sensor such as the ranging sensor 100 is deteriorated due to use, aging, or others will be described with an example.

### 2. First Embodiment

First, a first embodiment will be described in detail by referring to the drawings. Note that, in the present embodiment, a case where a sensor whose deterioration is to be corrected is a ranging sensor 100 and a device on which the ranging sensor 100 is mounted is a communication device 2 will be described as an example. However, the sensor is not limited to the ranging sensor 100, and various sensors such as an image sensor, a temperature sensor, a humidity sensor, or a radiation measuring instrument can be applied.

2.1 System Configuration

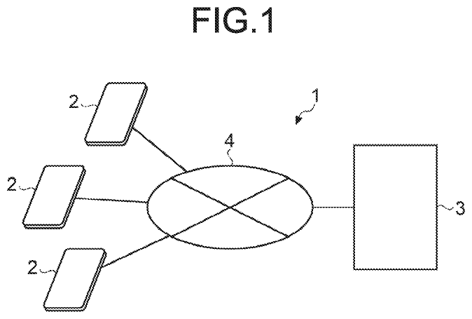

FIG. 1 is a schematic diagram illustrating a schematic configuration example of a sensor system according to the present embodiment. As illustrated in FIG. 1, in a sensor system 1, one or more communication devices 2 having a communication function and a server 3 are connected via a network 4.

The communication device 2 has a communication function for communicating with the server 3 via the network 4 as described above in addition to a ranging function. Note that, as the communication device 2, it is possible to apply various devices having a sensing function and a communication function such as a wearable terminal such as a smartphone and a mobile phone, a fixed device such as a fixed point camera or a monitoring camera, a travelling device such as a drone, an automobile, a home robot, a factory automation (FA) robot, a monitoring robot, or an autonomous robot, and a medical device.

The server 3 may be, for example, various servers connected to a network, such as a cloud server, a fog server, or an edge server. Furthermore, as the network 4, for example, it is possible to apply various networks such as the Internet, a local area network (LAN), a mobile communication network, and a public line network.

2.2 Device Configuration

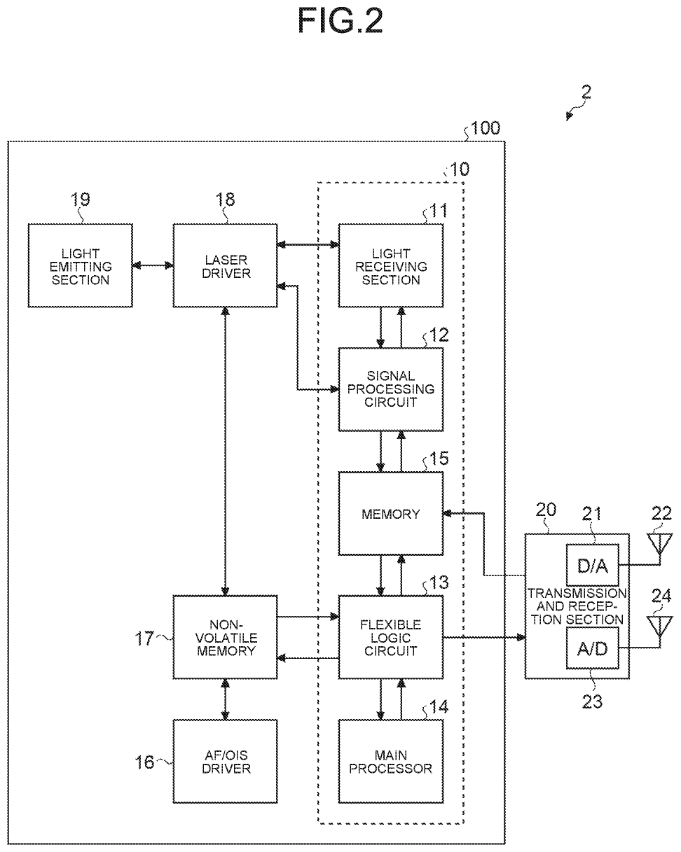

FIG. 2 is a block diagram illustrating a schematic configuration example of a ranging sensor in a communication device as an electronic device according to the embodiment. As illustrated in FIG. 2, a communication device 2 includes, for example, a ranging sensor 100 as a solid-state imaging device and a transmission and reception section 20. In the description, a case where the ranging sensor 100 is a ranging sensor of the indirect TOF scheme is given as an example, however, it is not limited thereto, and various ranging sensors such as a ranging sensor of the direct TOF scheme can be applied.

The ranging sensor 100 includes, for example, a sensor chip 10, an AF/OIS driver 16, a non-volatile memory 17, a laser driver 18, and a light emitting section 19. Note that, in the present example, a case where the AF/OIS driver 16, the non-volatile memory 17, the laser driver 18, and the light emitting section 19 are arranged outside the sensor chip 10 is illustrated, however, it is not limited thereto, and one or more of them may be arranged in the sensor chip 10. Meanwhile, in a case where the ranging sensor 100 has a fixed focus (FF), the AF/OIS driver 16 may be omitted.

(Sensor Chip 10)

The sensor chip 10 includes, for example, a light receiving section 11, a signal processing circuit 12, a flexible logic circuit 13, a main processor 14, and a memory 15.

Light Receiving Section 11

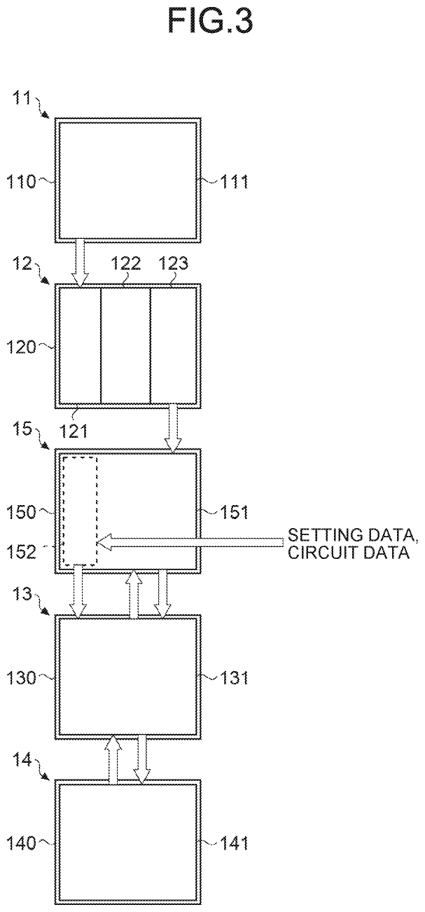

The light receiving section 11 includes, for example, an optical sensor array 111 (see FIG. 3) in which a plurality of photoelectric conversion elements is arranged in a two-dimensional lattice pattern. Each of the photoelectric conversion elements includes, for example, two read-out terminals TapA and TapB. In the following description, for the sake of simplicity, a pixel signal read from a read-out terminal TapA is denoted as TapA, and the pixel signal read from a read-out terminal TapB is denoted as TapB. However, the configuration of the light receiving section 11 is not limited thereto, and pixel signals TapA and TapB having phases different from each other by 180° may be read from two adjacent pixels.

Signal Processing Circuit 12

The signal processing circuit 12 includes, for example, a pixel circuit 121 (see FIG. 3) that reads a charge amount (corresponding to the amount of light) that is depth information from each of the two read-out terminals TapA and TapB of each photoelectric conversion element of the optical sensor array 111 and outputs the charge amount as pixel signals TapA and TapB, an analog circuit 122 (see FIG. 3) such as an analog-to-digital converter (ADC) that converts the analog pixel signals TapA and TapB read by the pixel circuit 121 into digital pixel signals TapA and TapB, and a logic circuit 123 (see FIG. 3) that executes correlated double sampling (CDS) processing or the like on the basis of the pixel signals TapA and TapB that have been converted into digital.

Memory 15

The memory 15 stores the digital pixel signals TapA and TapB output from the signal processing circuit 12. In addition, the memory 15 stores depth data subjected to predetermined processing by the flexible logic circuit 13 or the main processor 14 described later.

The memory 15 further stores various kinds of data for implementing a predetermined circuit configuration in a field-programmable gate array (FPGA) included in the flexible logic circuit 13. Hereinafter, data for implementing a circuit configuration by connecting logic components of an FPGA is referred to as circuit data, and a parameter given to the circuit configuration implemented by the circuit data is referred to as setting data.

Flexible Logic Circuit 13

As described above, the flexible logic circuit 13 includes the FPGA and generates depth data which is a ranging result by executing various kinds of processing, on the digital data (pixel signals TapA and TapB) stored in the memory 15, such as phase data processing, luminance data processing, periodic error correction, temperature correction, distortion correction, parallax correction, control system correction, automatic exposure (AE), automatic focus (AF), flaw correction, noise correction, (filter addition), flying pixel correction, depth calculation, and synchronous processing output interface (I/F) processing in cooperation with the main processor 14 to be described later.

Main Processor 14

The main processor 14 controls each of the components in the communication device 2. In addition, the main processor 14 operates in cooperation with the flexible logic circuit 13, thereby executing the various kinds of processing listed above as pipeline processing. That is, with the flexible logic circuit 13 executing a circuit change and functioning as an accelerator, the above processing is executed in a pipeline.

Non-Volatile Memory 17

The non-volatile memory 17 includes, for example, an electrically erasable programmable read-only memory (EEPROM) or the like and stores a parameter when the laser driver 18 drives the light emitting section 19. The non-volatile memory 17 also stores parameters and the like for the AF/OIS driver 16 to control a reading circuit and an actuator in the light receiving section 11, various circuits in the signal processing circuit 12, and others as necessary.

Laser Driver 18

The laser driver 18 generates a periodic light emission control signal for causing the light emitting section 19 to emit light at predetermined cycles on the basis of a parameter generated by the flexible logic circuit 13 and stored in the non-volatile memory 17.

Light Emitting Section 19

The light emitting section 19 includes, for example, a vertical cavity surface emitting laser (VCSEL), a light emitting diode (LED), or the like and emits light in accordance with a light emission control signal input from the laser driver 18.

AF/OIS Driver 16

The AF/OIS driver 16 includes, for example, a vertical drive circuit, a horizontal transfer circuit, a timing control circuit, and the like and drives a pixel circuit, described later, in the signal processing circuit 12, thereby causing the reading circuit in the light receiving section 11 to execute readout of the pixel signals TapA and TapB from the photoelectric conversion element. The AF/OIS driver 16 also controls an actuator that drives an optical system such as a lens and a shutter in the light receiving section 11.

Transmission and Reception Section 20

The transmission and reception section 20 is a communication section for communicating with the server 3 via the network 4 (see FIG. 1) and includes, for example, a DAC 21 that performs DA (digital-to-analog) conversion on transmission data, a transmission antenna 22 that transmits the DA-converted data to the network, a reception antenna 24 that receives data from a network, and an ADC 23 that performs AD (analog-to-digital) conversion on the data received by the reception antenna 24. However, the transmission and reception section 2018 is not limited to be wireless and may be wired. In the case of wired connection, the transmission and reception section 20 may be replaced with, for example, an interface section and be connected to an application processor, an electronic control unit (ECU), or the like.

2.3 Example of Stack Configuration of Sensor Chip

FIG. 3 is a schematic diagram illustrating a stack configuration example of the sensor chip 10 according to the present embodiment. As illustrated in FIG. 3, for example, the light receiving section 11, the signal processing circuit 12, the flexible logic circuit 13, the main processor 14, and the memory 15 in the sensor chip 10 each include one die.

The light receiving section 11 has a configuration in which the optical sensor array 111 is built in a light receiving chip 110 including a semiconductor substrate.

The signal processing circuit 12 has a configuration in which the pixel circuit 121, the analog circuit 122, and the logic circuit 123 are built in an analog logic chip 120 including a semiconductor substrate.

The flexible logic circuit 13 has a configuration in which an FPGA 131 is built in a flexible logic chip 130 including a semiconductor substrate. That is, the flexible logic circuit 13 has, for example, a system-on-a-chip (SoC) structure.

The main processor 14 has a configuration in which a micro processing unit (MPU) 141 is built in a processor chip 140 including a semiconductor substrate. Note that the number of MPUs 141 formed in the processor chip 140 is not limited to one and may be plural.

The memory 15 has a configuration in which a memory space 151 such as a static RAM (SRAM) or a dynamic RAM (DRAM) is built in a memory chip 150 including a semiconductor substrate. A partial space in the memory space 151 is used as a memory space (hereinafter, referred to as a programmable memory space) 152 for storing circuit data for setting a circuit configuration in the FPGA 131 or setting data thereof.

The chips 110, 120, 130, 140, and 150 are stacked from the top in the order illustrated in FIG. 3. Therefore, the sensor chip 10 has a stack structure in which the light receiving chip 110, the analog logic chip 120, the memory chip 150, the flexible logic chip 130, and the processor chip 140 are sequentially stacked.

Note that other configurations included in the ranging sensor 100, for example, the laser driver 18 and the non-volatile memory 17 may be built in separate chips or a shared chip or may be built in any of the chips 110, 120, 130, 140, and 150. Similarly, the transmission and reception section 20 may be built in a separate chip or may be built in any of the above chips.

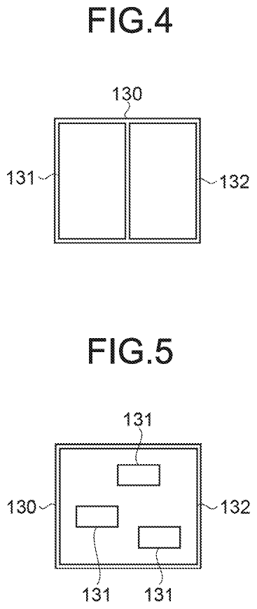

In addition, not only the FPGA 131 but also a logic circuit 132 may be built in the flexible logic chip 130 as illustrated in FIGS. 4 and 5. Note that illustrated in FIG. 4 is a case where the FPGA 131 and the logic circuit 132 are built in separate regions and that illustrated in FIG. 5 is a case where the FPGAs 131 are built in parts of the logic circuit 132.

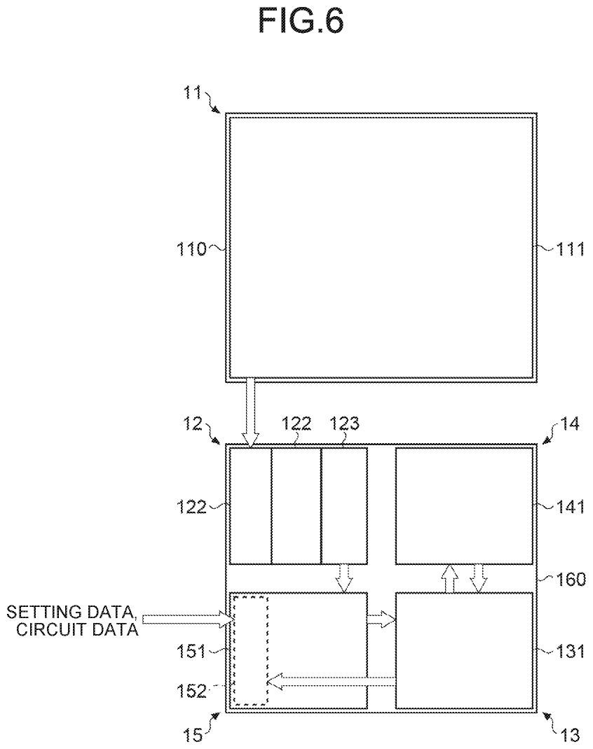

Furthermore, in the present embodiment, the stack structure in which the light receiving section 11, the signal processing circuit 12, the flexible logic circuit 13, the main processor 14, and the memory 15 built in the separate chips 110, 120, 130, 140, and 150, respectively, are stacked is given as an example, however, the stack structure can be variously modified as in the above-described embodiments. For example, in a case where a device that does not require high-speed depth processing is the communication device 2, as illustrated in FIG. 6, the signal processing circuit 12, the main processor 14, the flexible logic circuit 13, and the memory 15 can be in a single chip 160. In this case, since the number of manufacturing steps or the bonding process of the chips 120 to 150 can be reduced, the manufacturing cost can be suppressed. Furthermore, depending on the application, the main processor 14 can be omitted from the chip 160 in FIG. 6.

2.4 Another Specific Example of Stack Configuration

The stack configuration of the sensor chip 10 can also be modified as follows. However, the above-described specific examples and the specific examples below are merely examples, and various modifications can be made as necessary. Note that, in the following description, a layer close to the light incident plane, that is, a chip (corresponding to the light receiving chip 110) on which the light receiving section 11 is provided is referred to as a first layer.

2.4.1 First Modification

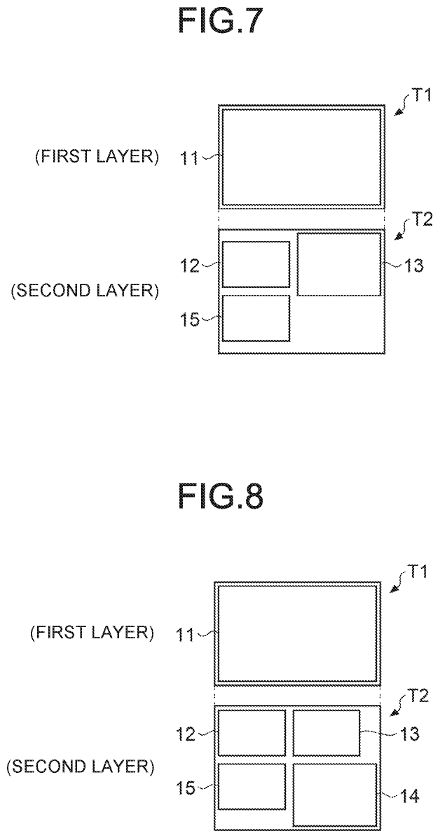

FIG. 7 is a schematic diagram illustrating a stack configuration according to a first modification of the sensor chip. As illustrated in FIG. 7, in the first modification, the sensor chip 10 may have a two-layer structure, the light receiving section 11 may be disposed on a chip T1 as the first layer, and the signal processing circuit 12, the flexible logic circuit 13, and the memory 15 may be arranged on a chip T2 as a second layer.

2.4.2 Second Modification

FIG. 8 is a schematic diagram illustrating a stack configuration according to a second modification of the sensor chip. As illustrated in FIG. 8, in the second modification, the main processor 14 may be further added to the second layer in a stack configuration similar to that of the sensor chip 10 (see FIG. 7) according to the first modification.

2.4.3 Third Modification

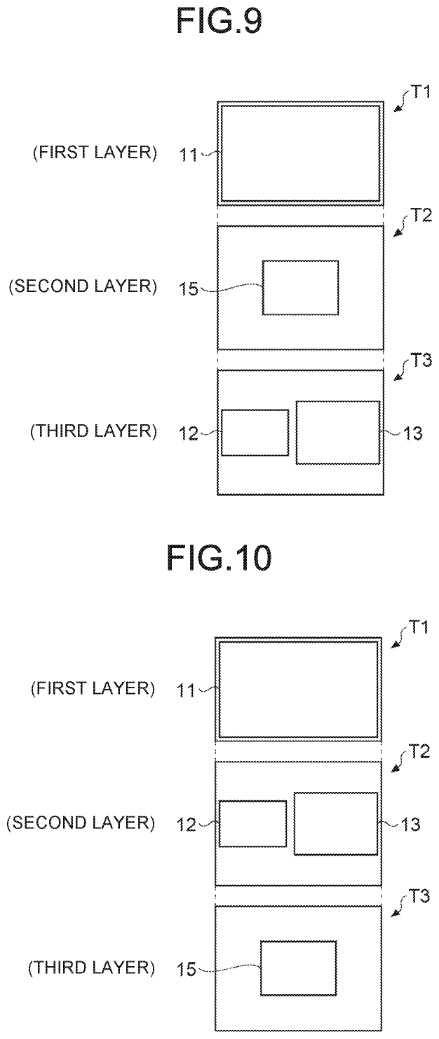

FIG. 9 is a schematic diagram illustrating a stack configuration according to a third modification of the sensor chip. As illustrated in FIG. 9, in the third modification, the sensor chip 10 may have a three-layer structure, the light receiving section 11 may be disposed on a chip T1 as a first layer, the memory 15 may be disposed on a chip T2 as a second layer, and the signal processing circuit 12 and the flexible logic circuit 13 may be arranged on a chip T3 as a third layer.

2.4.4 Fourth Modification

FIG. 10 is a schematic diagram illustrating a stack configuration according to a fourth modification of the sensor chip. As illustrated in FIG. 10, in the fourth modification, the chip T2 of the second layer and the chip T3 of the third layer are switched in a configuration similar to that of the sensor chip 10 (see FIG. 9) according to the third modification. That is, in the third modification, the signal processing circuit 12 and the flexible logic circuit 13 may be arranged on the chip T2 of the second layer, and the memory 15 may be disposed on the chip T3 of the third layer.

2.4.5 Fifth Modification

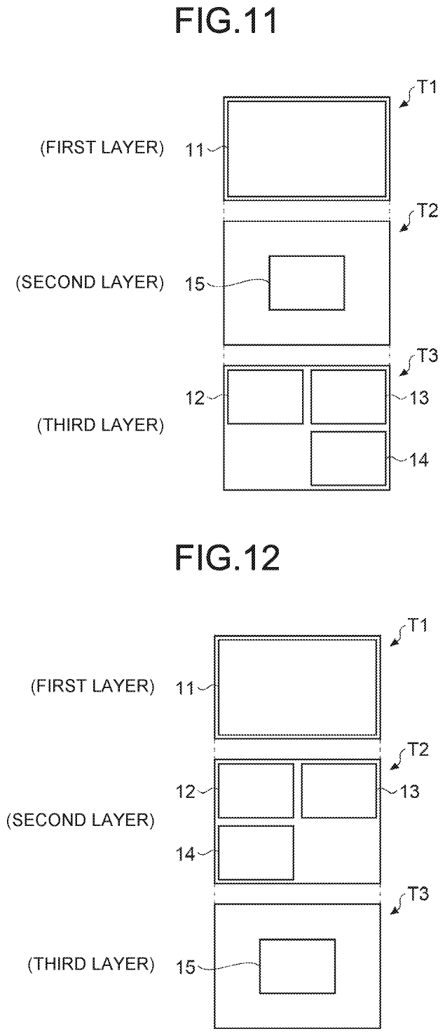

FIG. 11 is a schematic diagram illustrating a stack configuration according to a fifth modification of the sensor chip. As illustrated in FIG. 11, in the fifth modification, the main processor 14 may be further added to the third layer in a stack configuration similar to that of the sensor chip 10 (see FIG. 9) according to the third modification.

2.4.6 Sixth Modification

FIG. 12 is a schematic diagram illustrating a stack configuration according to a sixth modification of the sensor chip. As illustrated in FIG. 12, in the sixth modification, the main processor 14 may be further added to the second layer in a stack configuration similar to that of the sensor chip 10 (see FIG. 10) according to the fourth modification.

2.4.7 Seventh Modification

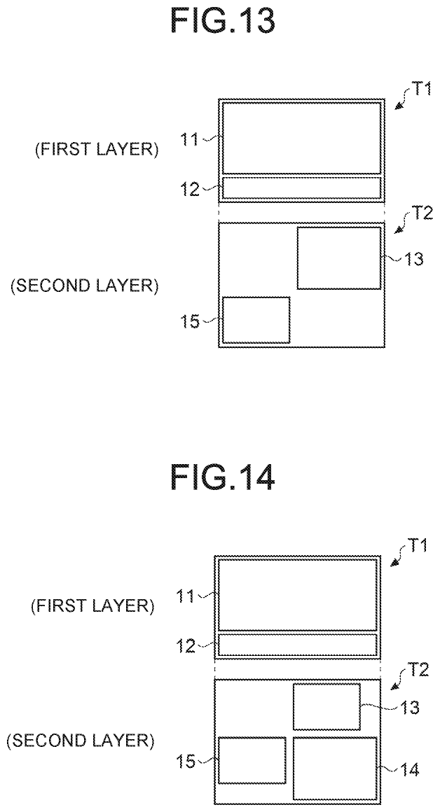

FIG. 13 is a schematic diagram illustrating a stack configuration according to a seventh modification of the sensor chip. As illustrated in FIG. 13, in the seventh modification, in a stack configuration similar to that of the sensor chip 10 (see FIG. 7) according to the first modification, the signal processing circuit 12 may be disposed not in a chip T2 of a second layer but in a chip T1 of a first layer.

2.4.8 Eighth Modification

FIG. 14 is a schematic diagram illustrating a stack configuration according to an eighth modification of the sensor chip. As illustrated in FIG. 14, in the eighth modification, the main processor 14 may be further added to the second layer in a stack configuration similar to that of the sensor chip 10 (see FIG. 13) according to the seventh modification.

2.4.9 Ninth Modification

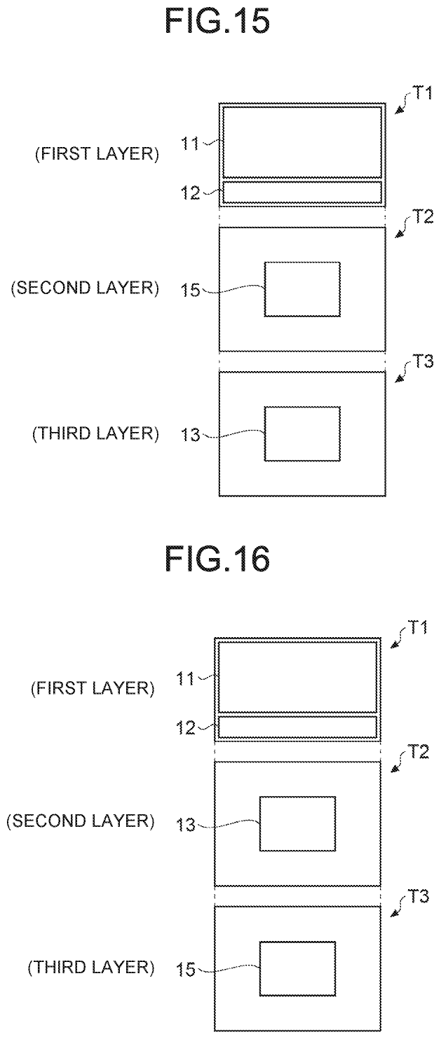

FIG. 15 is a schematic diagram illustrating a stack configuration according to a ninth modification of the sensor chip. As illustrated in FIG. 15, in the ninth modification, in a stack configuration similar to that of the sensor chip 10 (see FIG. 9) according to the third modification, the signal processing circuit 12 may be disposed not in a chip T1 of a third layer but in a chip T1 of a first layer.

2.4.10 Tenth Modification

FIG. 16 is a schematic diagram illustrating a stack configuration according to a tenth modification of the sensor chip. As illustrated in FIG. 16, in the tenth modification, the chip T2 of the second layer and the chip T3 of the third layer are switched in a configuration similar to that of the sensor chip 10 (see FIG. 15) according to the ninth modification. That is, in the third modification, the flexible logic circuit 13 may be disposed on a chip T2 of a second layer, and the memory 15 may be disposed on a chip T3 of a third layer.

2.4.11 Eleventh Modification

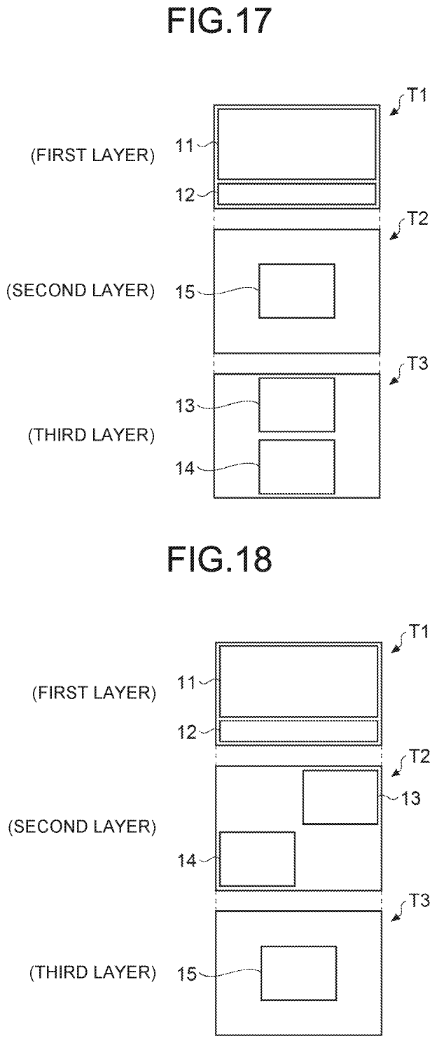

FIG. 17 is a schematic diagram illustrating a stack configuration according to an eleventh modification of the sensor chip. As illustrated in FIG. 17, in the eleventh modification, the main processor 14 may be further added to the third layer in a stack configuration similar to that of the sensor chip 10 (see FIG. 11) according to the fifth modification.

2.4.12 Twelfth Modification

FIG. 18 is a schematic diagram illustrating a stack configuration according to a twelfth modification of the sensor chip. As illustrated in FIG. 18, in the twelfth modification, the main processor 14 may be further added to a second layer in a stack configuration similar to that of the sensor chip 10 (see FIG. 17) according to the eleventh modification.

2.5 Operation Example of Sensing

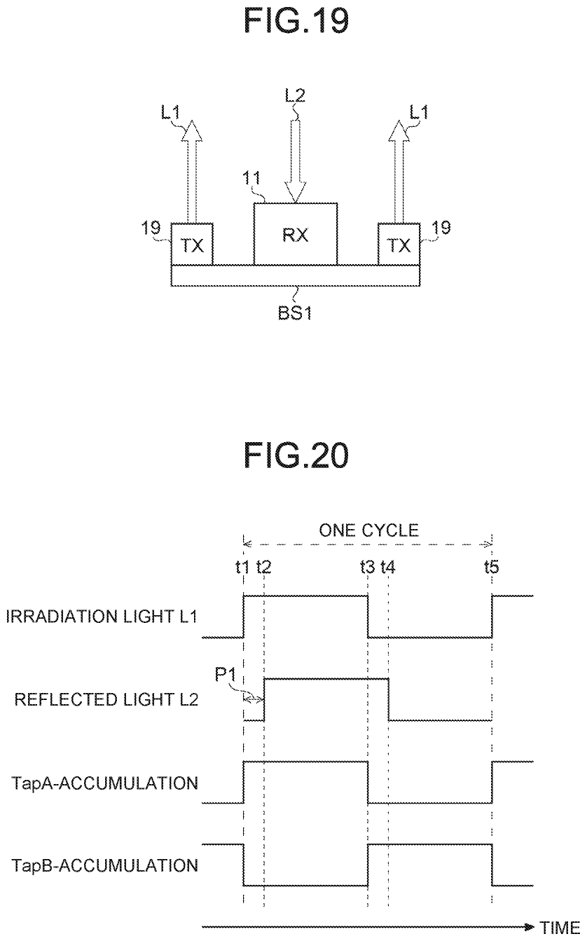

Next, an operation example of the ranging sensor 100 in the communication device 2 illustrated in FIG. 2 will be described. FIG. 19 is a side view of the ranging sensor according to the present embodiment. As illustrated in FIG. 19, the ranging sensor 100 has a configuration in which the sensor chip 10 and one or more light emitting sections 19 are provided on a base substrate BS1 and measures the distance to an object by detecting, by the sensor chip 10, reflected light L2 of irradiation light L1 emitted from the light emitting sections 19.

FIG. 20 is a waveform diagram illustrating a drive example of one cycle of pixels in the ranging sensor according to the present embodiment. As illustrated in FIG. 20, the light emitting sections 19 emit light at a duty ratio of 50% in each cycle. In the example illustrated in FIG. 20, the light emitting sections 19 emit light and output the irradiation light L1 during a period from timing t1 to t3 within a cycle from the timing t1 to t5. Meanwhile, in each pixel of the light receiving section 11, charge accumulation to a read-out terminal TapA is executed during the period from timing t1 to t3 corresponding to a first half of each cycle, and charge accumulation to a read-out terminal TapB is executed during a period from the timing t3 to t5 corresponding to a second half.

Note that, in a case where the reflected light L2 is incident on the light receiving section 11 with a delay of time P1 from the timing t1, the charge generated by photoelectric conversion of the reflected light L2 is accumulated in the read-out terminal TapA during the period from the timing t2 to t3, and the charge generated by photoelectric conversion of the reflected light L2 is accumulated in the read-out terminal TapB during the period from the timing t3 to t4. The charges accumulated in the respective read-out terminals TapA and TapB by the photoelectric conversion are read as pixel signals TapA and TapB.

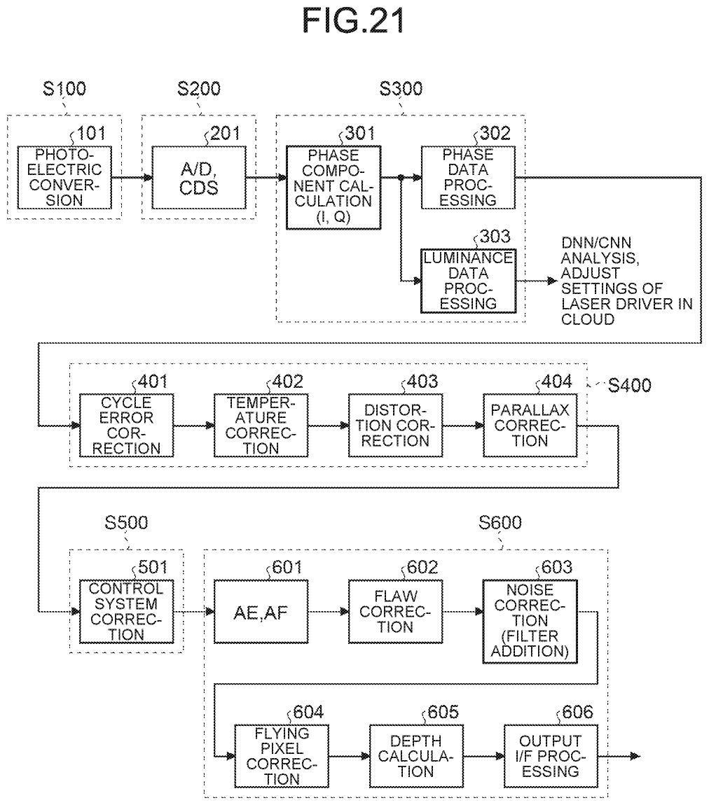

FIG. 21 is a flowchart illustrating an operation example of the ranging sensor according to the present embodiment. As illustrated in FIG. 21, the operation executed by the ranging sensor 100 can be roughly divided into six stages of a photoelectric conversion step S100, a signal processing step S200, a phase conversion step S300, a calibration step S400, a control system step S500, and a filtering step S600.

In the photoelectric conversion step S100, the photoelectric conversion elements of the light receiving section 11 perform photoelectric conversion 101 of the reflected light L2 that has entered at different time.

In the signal processing step S200, the charges accumulated in the respective read-out terminals TapA and TapB of the photoelectric conversion elements are read out as analog pixel signals TapA and TapB by the pixel circuit 121 (see FIG. 3) in the signal processing circuit 12. Note that the signal processing circuit 12 may adopt a method capable of simultaneously reading pixel signals from a plurality of pixels, such as a method of reading pixel signals row by row.

The analog pixel signals TapA and TapB that have been read out are converted into digital pixel signals TapA and TapB by an ADC of the logic circuit 123 (see FIG. 3) in the signal processing circuit 12 (201). Then, a CDS circuit in the signal processing circuit 12 performs the CDS processing on the AD-converted pixel signals TapA and TapB, thereby generating the pixel signals TapA and TapB from which noise has been removed (201). The generated pixel signals TapA and TapB may be temporarily stored in the memory 15.

In phase conversion step S300, phase component calculation (I, Q) 301 is executed on the pixel signals TapA and TapB, and phase data (for example, phase data of 0°, 90°, 180°, and 270°) for generating depth data is generated. Subsequently, phase data processing 302 and luminance data processing 303 are each executed on the generated phase data. The depth data which is a ranging result is generated by the phase data processing 302. On the other hand, the phase data subjected to the luminance data processing 303 may be transmitted to the server 3 and used to adjust parameters such as a voltage value for driving the laser driver 18.

The depth data generated by the phase data processing 302 is input to the calibration step S400. In the calibration step S400, cycle error correction 401, temperature correction 402, distortion correction 403, and parallax correction 404 are sequentially performed on the depth data.

In the control system step S500, for example, light emission control of the light emitting sections 19, optical axis control of the light receiving section 11, and the like are executed.

In the filtering step S600, automatic exposure (AE)/automatic focus (AF) 601, flaw correction 602, noise correction (filter addition) 603, flying pixel correction 604, and depth calculation 605 are executed. In the depth calculation 605, for example, information such as the distance to an object, depth noise, errors, and illuminance is calculated as depth data.

Note that, in output I/F processing 606, for example, the depth data once stored in the memory 15 may be the outside, the depth data output from the flexible logic circuit 13 or the main processor 14 may be directly output. The depth data output in the output I/F processing 606 is transmitted to the server 3 via the transmission and reception section 20, for example. In addition, the processing results (pixel signals, phase data, parameters, or the like for driving the light emitting section 19 and the light receiving section 11) output from the above-described steps S200, S300, S400, and S500 may also be transmitted to the server 3 via the transmission and reception section 20.

2.6 Relationship Between Each Piece of Processing and Chip

In the flow described with reference to FIG. 21, the photoelectric conversion step S100 is executed in the optical sensor array 111 (see FIG. 3) of the light receiving section 11, for example. Meanwhile, the AD conversion and the CDS processing (201) are executed in, for example, the ADC in the analog circuit 122 of the signal processing circuit 12 and the CDS circuit in the logic circuit 123.

Each processing of the phase conversion step S300, the calibration step S400, the control system step S500, the control system step S500, and the filtering step S600 is executed, for example, by reading circuit data for implementing one or more circuit configurations in the FPGA 131 of the flexible logic circuit 13 from the programmable memory space 152 of the memory 15, setting the circuit data in the FPGA 131, and registering setting data for each circuit configuration in a corresponding register. Therefore, by changing the setting data or the circuit data, the output in response to the input of each piece of processing can be adjusted.

Note that, as exemplified in FIG. 5 or 6, in a case where parts of the flexible logic circuit 13 are the FPGAs 131 and the rest is the logic circuit 132, it is also possible that the FPGAs 131 execute specific processing and that the logic circuit 132 executes the remaining processing.

In addition, the main processor 14 may operate in cooperation with the flexible logic circuit 13 so as to perform pipeline processing with regard to the processing executed by the flexible logic circuit 13.

2.7 Deterioration Correction of Ranging Sensor 100

In the above-described configuration, for example, the optical sensor array 111 of the ranging sensor 100 is deteriorated over time as the use frequency and the number of years of use increase. Such deterioration of the ranging sensor 100 can be corrected, for example, by changing the circuit configuration of the FPGA 131 or a parameter thereof.

Therefore, in the present embodiment, the deterioration state of the ranging sensor 100 is constantly detected periodically or at any timing, and the circuit configuration of the FPGA 131 and/or parameters thereof are changed depending on the detected deterioration state. This allows the ranging sensor 100 to be customized depending on the deterioration state, and thus it is possible to acquire accurate information (for example, ranging data) even in a case where the ranging sensor 100 is deteriorated due to use, aging, or the like.

The deterioration correction of the ranging sensor 100 is executed by, for example, transmitting the depth data and other data acquired by the ranging sensor 100 (This may include pixel signals, phase data, parameters for driving the light emitting sections 19 and the light receiving section 11. Hereinafter also referred to as depth performance) to the server 3 via the network 4. For example, the server 3 analyzes the depth performance received from the communication device 2 via the network 4, thereby specifying a deteriorated portion or a deterioration cause in the ranging sensor 100. Then, for the purpose of correcting the identified deteriorated portion or the deterioration cause, the server 3 generates setting data and/or circuit data to be set in the FPGA 131 of the flexible logic circuit 13 of the ranging sensor 100 and transmits (feeds back) the generated setting data and/or circuit data (hereinafter, the newly generated setting data and/or circuit data is also referred to as update data) to the communication device 2 via the network 4.

The communication device 2 that has received the setting data and/or the circuit data from the server 3 stores the setting data and/or the circuit data in the programmable memory space 152 of the memory 15 in the ranging sensor 100. The ranging sensor 100 sets the setting data and/or the circuit data stored in the programmable memory space 152 in the FPGA 131 and thereby corrects the deteriorated portion or the deterioration cause.

Note that the setting data and/or the circuit data for correcting the deteriorated portion or the deterioration cause can be generated using, for example, a learned model obtained by machine-learning of newly acquired data and/or depth performance that has been acquired in the past.

2.8 Procedure of Deterioration Correction

As a procedure of analyzing the depth performance on the server 3 side to change the setting and/or the circuit configuration of the flexible logic circuit 13 in the communication device 2, the following method can be described as an example.

Firstly, the communication device 2 transmits the depth performance (the distance, the depth noise, errors, the illuminance, and the like) calculated in the depth calculation 605 to the server 3.

Secondly, the server 3 analyzes the received depth performance (the distance, the depth noise, errors, the illuminance, and the like) (machine learning).

Thirdly, the server 3 generates setting data and/or circuit data on the basis of the analysis result.

Fourthly, the server 3 feeds back the generated setting data and/or circuit data to a communication device 2 (binary data transfer).

Fifthly, the communication device 2 writes the received setting data and/or circuit data to a predetermined address in the programmable memory space 152 of the memory 15.

Sixthly, the communication device 2 reads the setting data and/or the circuit data in the programmable memory space 152, sets the circuit data in the FPGA 131, and registers the setting data in the register, thereby configuring a new circuit in the FPGA 131 or changing a parameter of the circuit configuration implemented in the FPGA 131.

By executing the above operation, for example, frame by frame, the FPGA 131 can be updated at all times.

Note that the layer configuration of the flexible logic can be modified as required depending on the application such as one including only the FPGA 131 (see FIG. 3 or FIG. 4), one including the FPGAs 131 and the logic circuit 132 (see FIG. 5), and one including a mixture of the FPGA 131 and the logic circuit 132 (the FPGA 131 performs circuit change on the circuit of the logic circuit 132 that is the basis. see FIG. 6).

In addition, on the basis of the result of machine learning on the server 3 side, it is also possible to implement addition of a new circuit to the FPGA 131, to change of the circuit configuration of the FPGA 131 for speed improvement (for example, omit some of the functions), and the like. For example, changing the data output from the signal processing circuit 12 from 10 bit depth data to 14 bit depth data or to 8 bit depth data is also made possible by changing the circuit configuration of the FPGA 131.

2.9 Analysis of Depth Performance (Machine Learning)

As described above, the deterioration state of the ranging sensor 100 can be determined, for example, by analyzing the depth performance acquired by the ranging sensor 100. In the analysis of the depth performance, for example, the depth performance acquired by the ranging sensor 100 is stored on the server side, and whether or not the ranging sensor 100 is deteriorated can be determined by comparing the stored depth performance with newly acquired depth performance at the time of analyzing the depth performance.

At this point, as the depth performance to be stored on the server 3 side, it is preferable to use depth performance at a stage where the aging deterioration of the ranging sensor 100 is insignificant, such as the depth performance having been acquired before shipping of the communication device 2 or the depth performance having been acquired at the time of default setting when the communication device 2 has arrived at the user.

Meanwhile, the depth performance transmitted from the communication device 2 to the server 3 for deterioration determination may be depth performance acquired at any timing or depth performance acquired when a predetermined condition is satisfied. Note that, the predetermined condition can be that the depth performance is obtained when the same area is captured as an image as that for the depth performance stored in the server 3, that the depth performance is obtained by capturing an image under the same illuminance condition as that when the depth performance stored in the server 3 has been captured as an image, or others.

Alternatively, for example, in a case where the ranging sensor 100 includes a mechanical shutter, the depth performance acquired in a state where the mechanical shutter is closed may be stored on the server 3 side, and at the time of deterioration determination, the depth performance may be acquired in a state where the mechanical shutter is also closed, and the depth performance may be transmitted to the server 3. In this case, the deterioration state of the ranging sensor 100 can be checked from a black level, the noise, a defective pixel, or others.

Furthermore, in the analysis of the depth performance, for example, by learning the state of deterioration in the depth performance and the cause thereof by machine learning and constructing a learned model, the accuracy and the speed of the cause investigation at a time of later analysis can be listed. Note that, as a method of machine learning, various methods such as a recurrent neural network (RNN), a convolution neural network (CNN), and a deep learning neural network (DNN) can be used.

2.10 Operation Flow

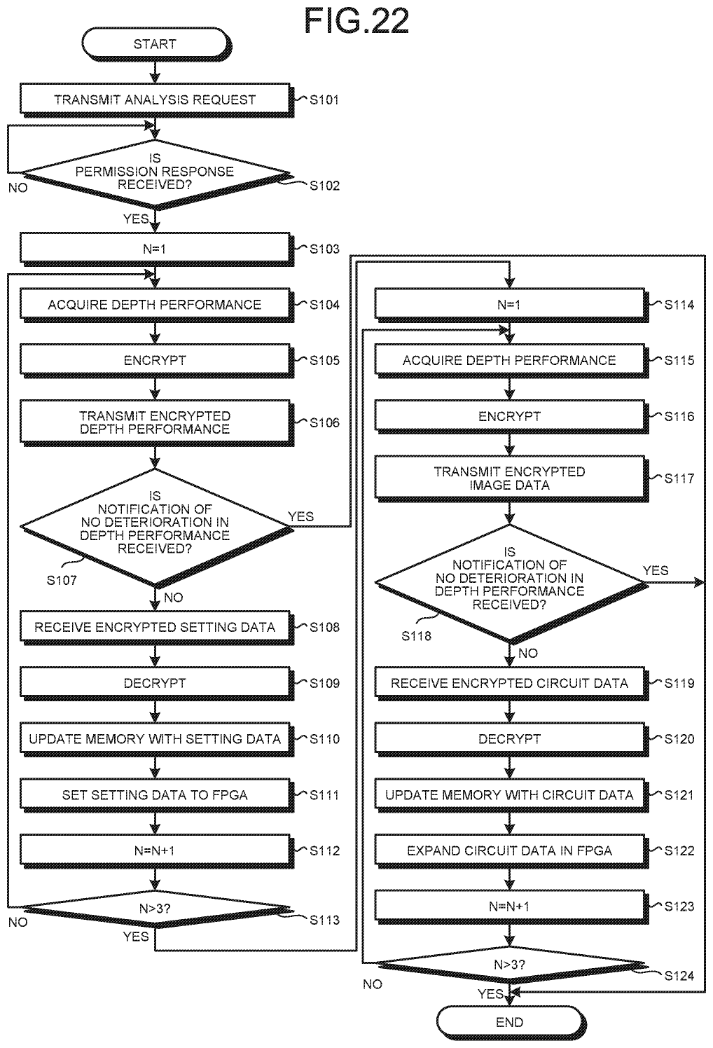

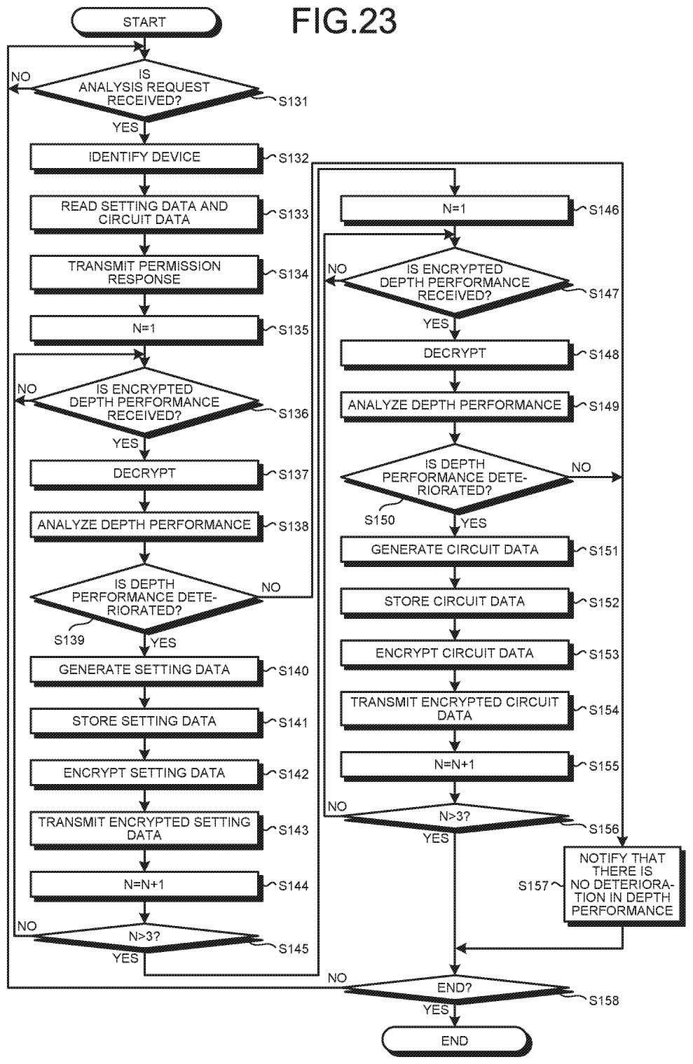

Next, the operation when deterioration of the ranging sensor 100 is detected and corrected will be described in detail with a flowchart. FIG. 22 is a flowchart illustrating a schematic operation example of the communication device according to the present embodiment. FIG. 23 is a flowchart illustrating a schematic operation example of the server according to the embodiment.

2.10.1 Operation Example of Communication Device 2

As illustrated in FIG. 22, the communication device 2 first requests the server 3 to analyze the depth performance acquired by the ranging sensor 100 at all times or periodically (step S101) and waits for receiving an analysis permission response from the server 3 (NO in step S102). If an analysis permission response is received from the server 3 (YES in step S102), the communication device 2 sets 1 to a value N for managing the number of repetitions of analysis (step S103). Subsequently, the communication device 2 drives the ranging sensor 100 and acquires the depth performance (step S104). The depth performance acquired at this point may be the depth performance subjected to the processing of the stages exemplified in FIG. 21.

Next, the communication device 2 encrypts the depth performance after DA conversion into analog data (step S105). Note that the encryption may be executed, for example, in the main processor 14 or an application processor (encryption section) (not illustrated). Subsequently, the communication device 2 transmits the encrypted depth performance to the server 3 via the network 4 (step S106) and waits for a response from the server 3 (NO in step S107). In response to this, as will be described later with reference to FIG. 23, the server 3 analyzes the depth performance received from the communication device 2 and, in a case where it is recognized that the depth performance is deteriorated, the server 3 generates setting data to be set in the FPGA 131 in order to resolve the deterioration in the depth performance.

If an analysis result indicating that the depth performance is not deteriorated is received from the server 3 (YES in step S107), the communication device 2 ends this operation. On the other hand, if an analysis result indicating that the depth performance is deteriorated is received (NO in step S107), the communication device 2 receives encrypted setting data from the server 3 via the network 4 (step S108) and decrypts the received encrypted setting data (step S109). Note that unlocking of encryption (decryption) may be executed by, for example, the main processor 14 or an application processor (decryption section) (not illustrated). Subsequently, the communication device 2 updates the setting data of the FPGA 131 stored in the programmable memory space 152 of the memory space 151 with the decrypted setting data (step S110) and sets the updated setting data in the FPGA 131 (step S111). Note that, in a case where the received setting data includes setting data for the laser driver 18 of the light emitting sections 19, an actuator for driving the AF/OIS driver 16 or the optical system of the light receiving section 11, or each of the components of the signal processing circuit 12, the communication device 2 updates predetermined parameters in the non-volatile memory 17 with this setting data. As a result, driving of each component by the laser driver 18 and/or the AF/OIS driver 16 is adjusted.

Next, the communication device 2 increments the number of repetitions N by 1 (step S112) and determines whether or not the incremented value N is larger than a preset upper limit value of the number of repetitions (3 in this example) (step S113). If the number of repetitions N is equal to or less than the upper limit value (NO in step S113), the communication device 2 returns to step S104 and executes the subsequent operations again. On the other hand, if the number of repetitions N is larger than the upper limit value (YES in step S113), the communication device 2 proceeds to step S114.

In step S114, the communication device 2 resets the number of repetitions N to 1. Subsequently, similarly to steps S104 to 107 described above, the communication device 2 encrypts the depth performance acquired from the ranging sensor 100 after DA conversion and transmits the encrypted depth performance to the server 3 (step S106) and then waits for a response from the server 3 (NO in steps S115 to S118). In response to this, as will be described later with reference to FIG. 8, the server 3 analyzes the depth performance received from the communication device 2 and, in a case where it is recognized that the depth performance is deteriorated, the server 3 generates circuit data to be incorporated in the FPGA 131 in order to resolve the deterioration in the depth performance.

If an analysis result indicating that the depth performance is not deteriorated is received from the server 3 (YES in step S118), the communication device 2 ends this operation. On the other hand, if an analysis result indicating that the depth performance is deteriorated is received (NO in step S118), the communication device 2 receives encrypted circuit data from the server 3 via the network 4 (step S119) and decrypts the received encrypted circuit data (step S120). Subsequently, the communication device 2 updates the circuit data of the FPGA 131 stored in the programmable memory space with the decrypted circuit data (step S121) and incorporates the updated circuit data into the FPGA 131, thereby changing the circuit configuration of the FPGA 131 (step S122).

Next, the communication device 2 increments the number of repetitions N by 1 (step S123) and determines whether or not the incremented value N is larger than a preset upper limit value of the number of repetitions (3 in this example) (step S124). If the number of repetitions N is equal to or less than the upper limit value (NO in step S124), the communication device 2 returns to step S115 and executes the subsequent operations again. On the other hand, if the number of repetitions N is larger than the upper limit value (YES in step S124), the communication device 2 ends this operation.

2.10.2 Operation Example of Server 3

As illustrated in FIG. 23, after starting the present operation, the server 3 waits until receiving an analysis request from the communication device 2 (NO in step S131). If receiving an analysis request (YES in step S131), the server 3 first specifies the communication device 2 that has transmitted the analysis request (step S132).

Next, after successfully specifying the communication device 2 that has transmitted the analysis request, the server 3 reads the circuit data and/or the setting data stored in the programmable memory space 152 of the specified communication device 2 from a predetermined storage device (step S133) and transmits an analysis permission response to the communication device 2 that has transmitted the analysis request (step S134). Note that the storage device of the server 3 stores, for each communication device 2, circuit data and/or setting data stored in a programmable memory space 152 of a registered communication device 2. That is, circuit data and/or setting data of each communication device 2 are/is shared between the communication device 2 and the server 3.

Next, the server 3 sets the number of repetitions N to 1 (step S135) and then waits until encrypted depth performance is received from the communication device 2 (NO in step S136). If the encrypted depth performance is received (YES in step S136), the server 3 decrypts the encrypted depth performance (step S137), analyzes the decrypted depth performance (step S138), and determines whether or not the depth performance is deteriorated on the basis of the result (step S139).

If there is no deterioration in the depth performance (NO in step S139), the server 3 notifies the communication device 2 that there is no deterioration in the depth performance (step S157) and the process proceeds to step S158. On the other hand, if there is deterioration in the depth performance (YES in step S139), a portion that causes the deterioration in the depth performance in the ranging sensor 100 is specified on the basis of the analysis result of step S138, and new setting data for the specified portion is generated (step S140). Then, the server 3 stores the generated setting data in a predetermined storage device in association with the communication device 2 (step S141), encrypts the generated setting data (step S142), and transmits the encrypted setting data to the communication device 2 via the network 4 (step S143). Note that, as described above, a learned model obtained by machine learning for newly acquired data and/or depth performance acquired in the past may be used to generate the new setting data.

Next, the server 3 increments the number of repetitions N by 1 (step S144) and determines whether or not the incremented value N is larger than a preset upper limit value of the number of repetitions (3 in this example) (step S145). If the number of repetitions N is equal to or less than the upper limit value (NO in step S145), the server 3 returns to step S136 and executes the subsequent operations again. On the other hand, if the number of repetitions N is larger than the upper limit value (YES in step S145), the server 3 proceeds to step S146.

In step S146, the server 3 resets the number of repetitions N to 1. Subsequently, the server 3 waits until the encrypted depth performance is received from the communication device 2 (NO in step S147). If encrypted depth performance is received (YES in step S147), the server 3 decrypts the encrypted depth performance (step S148), analyzes the decrypted depth performance (step S149), and determines whether or not the depth performance is deteriorated on the basis of the result (step S150).

If there is no deterioration in the depth performance (NO in step S150), the server 3 notifies the communication device 2 that there is no deterioration in the depth performance (step S157) and the process proceeds to step S158. On the other hand, if there is deterioration in the depth performance (YES in step S150), a portion that causes the deterioration in the depth performance in the ranging sensor 100 is specified on the basis of the analysis result of step S149, and new circuit data for the specified portion is generated (step S151). Then, the server 3 stores the generated circuit data in a predetermined storage device in association with the communication device 2 (step S152), encrypts the generated circuit data (step S153), and transmits the encrypted circuit data to the communication device 2 via the network 4 (step S154). Note that, as described above, a learned model obtained by machine learning for newly acquired data and/or depth performance acquired in the past may be used to generate the new circuit data.

Next, the server 3 increments the number of repetitions N by 1 (step S155) and determines whether or not the incremented value N is larger than a preset upper limit value of the number of repetitions (3 in this example) (step S156). If the number of repetitions N is equal to or less than the upper limit value (NO in step S156), the server 3 returns to step S147 and executes the subsequent operations again. On the other hand, if the number of repetitions N is larger than the upper limit value (YES in step S156), the server 3 proceeds to step S158.

In step S158, the server 3 determines whether or not to end the present operation and ends the operation if the operation is to be ended (YES in step S158). On the other hand, if the operation is not to be ended (NO in step S158), the server 3 returns to step S131 and executes the subsequent operations.

By executing the operation as described above, the circuit configuration and/or parameters of the FPGA 131 in the flexible logic circuit 13 of the communication device 2 are customized, and the deterioration of the ranging sensor 100 is corrected. As a result, the communication device 2 can acquire depth data in a favorable state.

Note that the frequency of uploading the depth performance from the communication device 2 to the server 3 may be modified as required. In addition, for example, in FA, a drone, an automobile, a robot, or the like in which being real-time is important, it is preferable that the data amount of the depth performance transmitted from the communication device 2 to the server 3 be small. In such a case, in order to reduce the data amount of the depth performance, the depth performance to be transmitted may be compressed at the VGA level or the QVGA level, or data may be compressed by binning or the like.

2.11 Deterioration Factor of Ranging Sensor 100

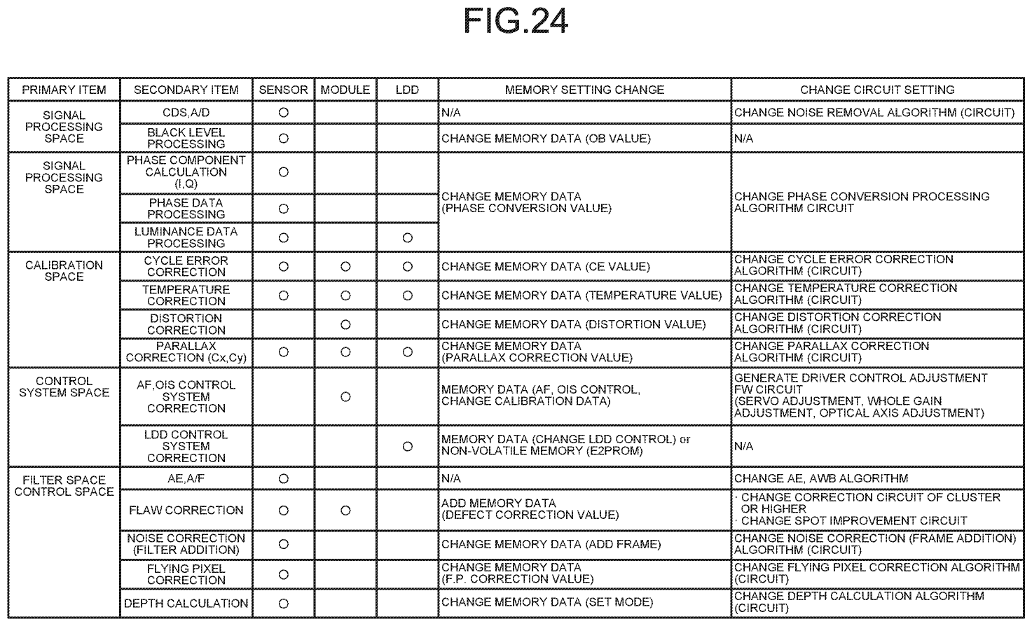

As illustrated in FIG. 24, the deterioration is caused by a photoelectric conversion element in the optical sensor array 111 of the ranging sensor 100, an Rx module of an optical system such as a lens or an actuator, a Tx module of a light emitting system such as the light emitting section 19 and the laser driver 18, or the like.

Therefore, as in the present embodiment, by changing the setting data and/or changing the circuit data, for example, it is possible to suppress deterioration of the depth performance in an area with an imaged height equal to or higher than 80%. Note that the configuration may allow the memory 15 to be added in a case where it is desired to add the memory 15.

2.12 High-Speed Processing Method

Next, a method of high-speed processing executed by the communication device 2 according to the embodiment will be described in comparison with the related art.

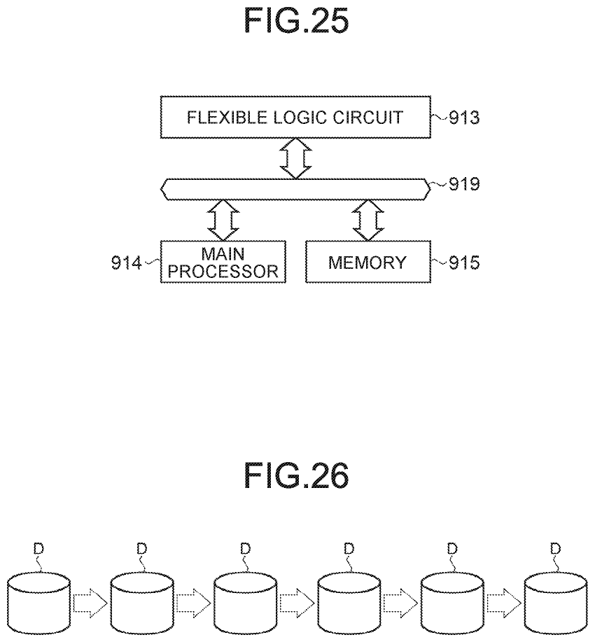

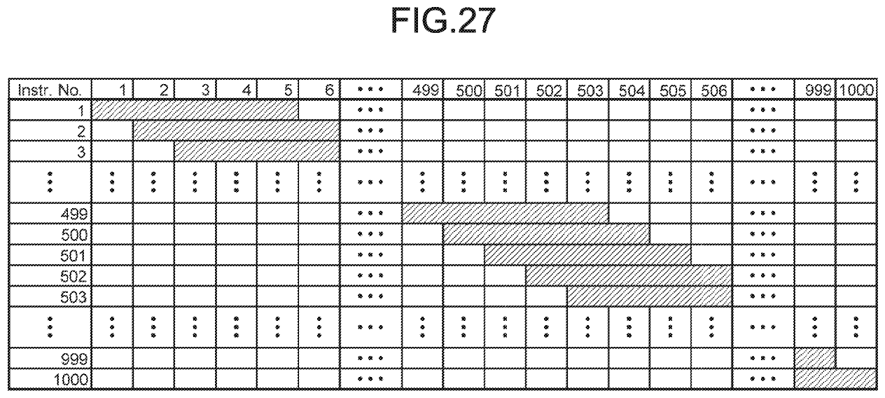

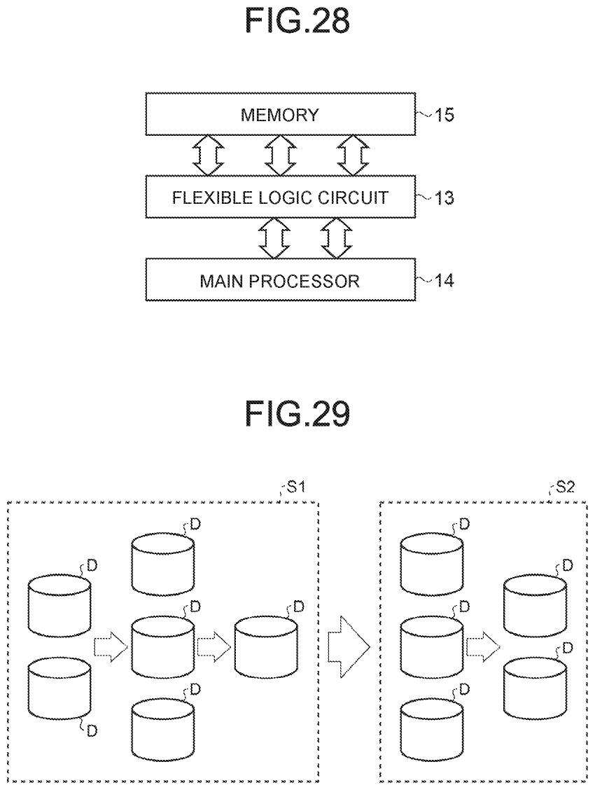

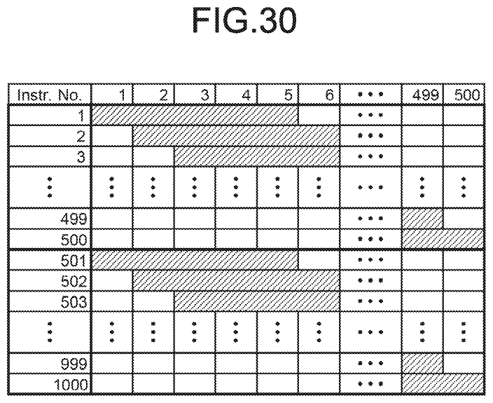

FIG. 25 is a block diagram illustrating a conventional device configuration. FIG. 26 is a diagram for describing a flow performed when data is processed with the device configuration exemplified in FIG. 25. FIG. 27 is a diagram illustrating the number of clock cycles required to process 1000 pieces of data in the device configuration exemplified in FIG. 25. On the other hand, FIG. 28 is a block diagram illustrating the device configuration of the ranging sensor 100 according to the embodiment. FIG. 29 is a diagram for explaining a flow when the ranging sensor 100 according to the embodiment processes data. FIG. 30 is a diagram illustrating the number of clock cycles required when the ranging sensor 100 according to the embodiment processes 1000 pieces of data.

As illustrated in FIG. 25, in a conventional device configuration in which a logic circuit 913, a main processor 914, and a memory 915 are connected via a bus 919, the logic circuit 913, the main processor 914, and the memory 915 are mounted together in one layer. Therefore, a complicated program can be flexibly executed by sequential processing.

However, since the mechanism is to share the memory 915 between the circuits (also referred to as arithmetic units) that execute each processing, there are disadvantages such as a decrease in the performance with an increase in the number of processor cores and an increase in time for parallel processing. For example, when each processing exemplified in FIG. 21 is executed, it is necessary for the main processor 914 to ingest target data piece by piece from the memory 915 via the bus 919 and to sequentially input the data to the logic circuit 913 to execute the processing. Therefore, in the conventional device structure, as illustrated in FIG. 26, the flow of processing is sequential such as that the processing for each data D is sequentially performed.

Therefore, for example, in a case where 1000 instructions at the same level are processed, since the number of instructions that can be executed per clock is one, at least 1000 clock cycles are required in order to process all the instructions as illustrated in FIG. 27.

On the other hand, the ranging sensor 100 according to the present embodiment has a stack structure in which the chips 110, 120, 130, 140, and 150 that execute each processing are stacked. Therefore, in the ranging sensor 100, as illustrated in FIG. 28, the flexible logic circuit 13 can directly ingest data from the memory 15 and process the data.

By taking advantage of such a stack structure, advantages can be obtained such as that it is possible to flexibly execute a complicated program and to process in parallel with the main processor 14 ingesting data in a cue and the flexible logic circuit 13 generating registers and arithmetic circuits. For example, as illustrated in FIG. 29, the ranging sensor 100 can perform pipeline processing of processing a plurality of pieces of data D in parallel.

By making it possible to perform parallel processing in this manner, real-time performance can be improved. In addition, even in a case where next processing is another kind of processing, it is possible to flexibly execute a complex program by changing the circuit configuration of the FPGA.

In addition, for the pipeline processing, parallel processing can be performed even in one layer by changing the circuit of the FPGA of the flexible logic section.

For example, in a case where the number of instructions that can be executed per clock is set to two, that is, in a case where the concurrency of the pipeline processing is set to 2, as illustrated in FIG. 30, the number of clock cycles required to process 1000 instructions at the same level can be reduced to 500 clock cycles, which is half the number for the conventional device structure exemplified in FIG. 27, for example. That is, by further increasing the concurrency of the pipeline processing, it is possible to reduce the number of clock cycles required to process instructions at the same level to about a reciprocal of several times the number.

In addition, as illustrated in FIG. 29, by machine-learning the first processing S1, it becomes possible to reduce the number of pieces of data D to be processed in second and subsequent processing S2, and thus, it is also possible to implement faster processing.

Note that addition of a new circuit to the FPGA 131, change of a circuit configuration for improving the processing speed (improvement of parallel processing, omission of some functions, and the like), and the like may be performed by machine learning based on analysis of depth performance on the server 3 side.

2.13 Action and Effects

As described above, according to the present embodiment, it is possible to change the parameters and the circuit configuration of the FPGA 131 so as to correct the deterioration in the depth performance on the basis of the depth performance acquired by the ranging sensor 100. This makes it possible to acquire accurate depth performance even in a case where the ranging sensor 100 is deteriorated.

In addition, the present embodiment makes it possible to flexibly operate a complicated program by a flexible logic chip, to ingest data during standby of the main processor 14 and to generate registers and arithmetic circuits on the FPGA 131 side, and to perform parallel processing on the processing in a pipeline. This makes it possible to improve the real-time performance and to flexibly cope with a complicated program.

### 3. Second Embodiment

The embodiment described above exemplified the cases where the cause of deterioration is identified by analyzing the depth performance acquired by the ranging sensor 100 on the server 3 side, and the server 3 generates update data of setting data and/or circuit data of the FPGA 131 on the basis of the identified cause of the deterioration. Meanwhile, in the second embodiment, a case where the communication device 2 side executes analysis of the depth performance up to generation of update data will be described with an example. Note that, in the following description, the similar components to those of the above-described embodiments are denoted by the same symbols, and redundant description thereof will be omitted.

3.1 Device Configuration

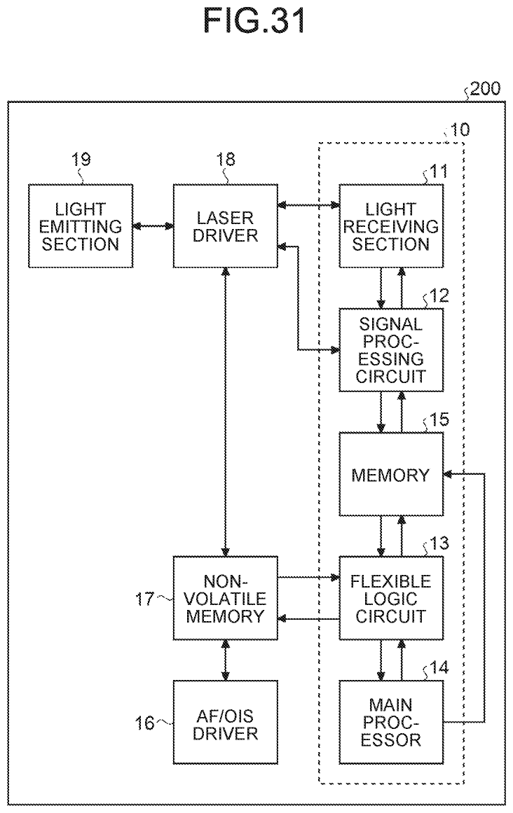

FIG. 31 is a block diagram illustrating a schematic configuration example of the ranging sensor according to the present embodiment. As illustrated in FIG. 31, a ranging sensor 200 in the communication device 2 according to the present embodiment has, for example, a configuration similar to that of the ranging sensor 200 described with reference to FIG. 2 in the first embodiment. However, in the present embodiment, for example, a main processor 14 analyzes the depth performance stored in a memory 15 to identify the cause of the deterioration and generates update data of setting data and/or circuit data of an FPGA 131 on a basis of the identified cause of the deterioration. The generated update data of setting data and/or circuit data are stored in a predetermined programmable memory space 152 in the memory 15 and set in the FPGA 131, similarly to the above embodiment.

Note that, similarly to the server 3 in the above embodiment, the main processor 14 may generate a learned model by performing machine learning on newly acquired data and/or depth performance acquired in the past and generate update data of setting data and/or circuit data using the generated learned model.

3.2 Action and Effects

As described above, according to the present embodiment, even in a case where the communication device 2 side performs the analysis of the depth performance up to generation of the update data, similarly to the above-described embodiment, it is possible to change the parameters or the circuit configuration of the FPGA 131 so as to correct the deterioration in the depth performance on the basis of the depth performance acquired by the ranging sensor 200. This makes it possible to acquire accurate depth performance even in a case where the ranging sensor 200 is deteriorated.

Other configurations, operations, and effects may be similar to those of the above-described embodiments, and thus detailed description is omitted here.

### 4. Third Embodiment

In the second embodiment described above, the case where the main processor 14 executes the machine learning to create the learned model and generates the update data of setting data and/or circuit data using the learned model has been described as an example. However, in a case where the communication device 2 side executes the analysis of the depth performance up to generation of the update data as described above, a dedicated chip for executing the machine learning may be included in the communication device 2. Note that, in the following description, the similar components to those of the above-described embodiments are denoted by the same symbols, and redundant description thereof will be omitted.

4.1 Device Configuration

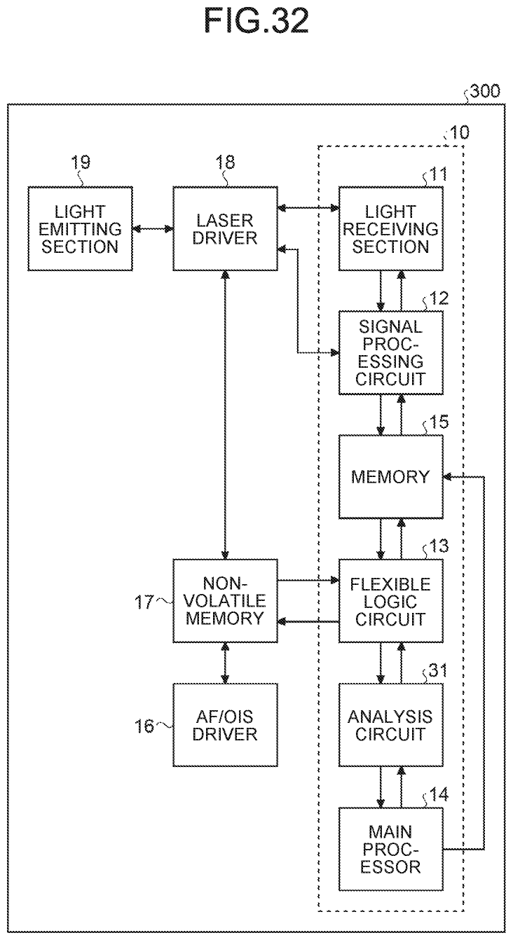

FIG. 32 is a block diagram illustrating a schematic configuration example of the ranging sensor according to the present embodiment. As illustrated in FIG. 32, the ranging sensor 100 in the communication device 2 according to the present embodiment has, for example, a configuration in which an analysis circuit 31 that executes machine learning such as deep neural network (DNN) and/or convolutional neural network (CNN) and analyzes depth performance (pixel signals, phase data, parameters for driving a light emitting section 19 and a light receiving section 11, depth data, etc.) acquired by a ranging sensor 300 is added to a configuration similar to that of the ranging sensor 200 described with reference to FIG. 31 in the second embodiment.

4.2 Example of Stack Configuration of Sensor Chip

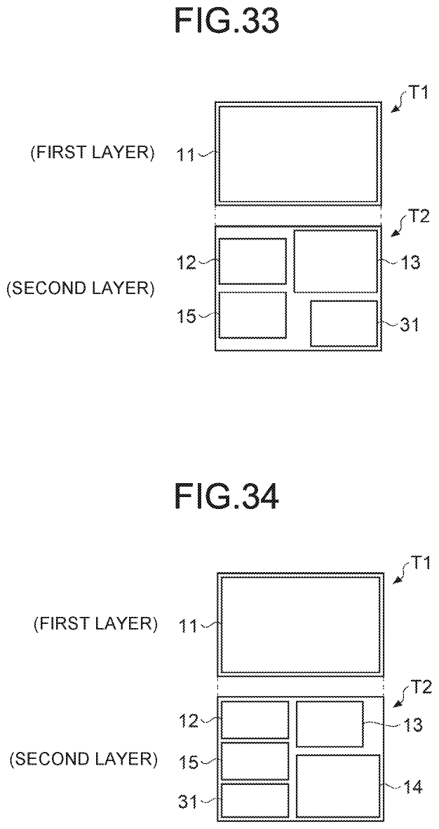

The stack configuration of a sensor chip 10 according to the present embodiment may be, for example, a stack configuration in which a DNN chip in which the analysis circuit 31 is built is disposed between a flexible logic chip 130 and a processor chip 140 in a configuration similar to the stack configuration described with reference to FIG. 3 in the first embodiment. However, it is not limited thereto, and for example, as illustrated in FIGS. 33 to 44, the stack configuration of the sensor chip 10 can be modified.

FIG. 33 is a schematic diagram illustrating the stack configuration according to the first modification of the sensor chip, and the analysis circuit 31 is added in the second layer in a stack configuration similar to that of the sensor chip 10 according to the first modification of the first embodiment exemplified in FIG. 7.

FIG. 34 is a schematic diagram illustrating the stack configuration according to the second modification of the sensor chip, and the analysis circuit 31 is added in the second layer in a stack configuration similar to that of the sensor chip 10 according to the second modification of the first embodiment exemplified in FIG. 8.

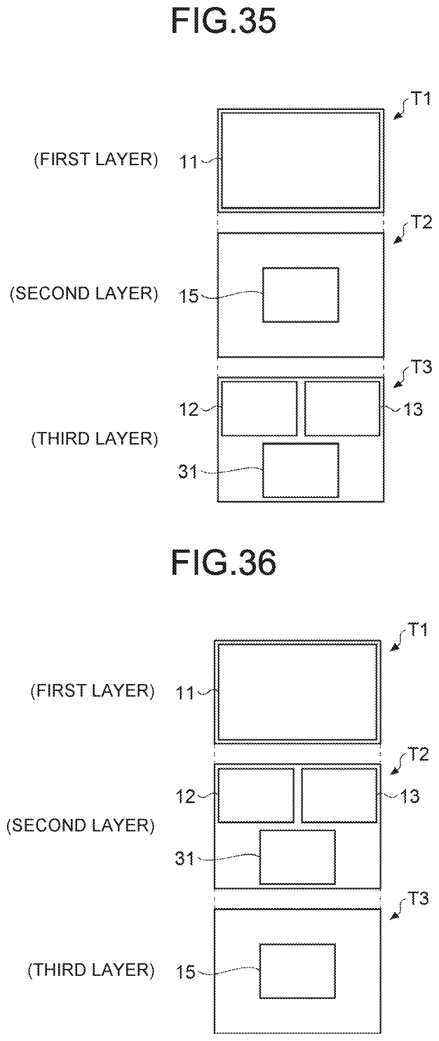

FIG. 35 is a schematic diagram illustrating the stack configuration according to the third modification of the sensor chip, and the analysis circuit 31 is added in the third layer in a stack configuration similar to that of the sensor chip 10 according to the third modification of the first embodiment exemplified in FIG. 9.

FIG. 36 is a schematic diagram illustrating the stack configuration according to the fourth modification of the sensor chip, and the analysis circuit 31 is added in the second layer in a stack configuration similar to that of the sensor chip 10 according to the fourth modification of the first embodiment exemplified in FIG. 10.

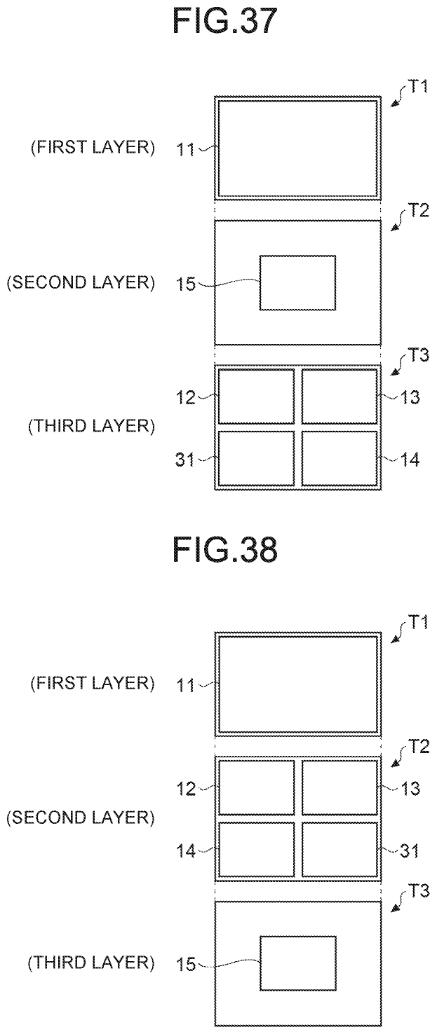

FIG. 37 is a schematic diagram illustrating the stack configuration according to the fifth modification of the sensor chip, and the analysis circuit 31 is added in the third layer in a stack configuration similar to that of the sensor chip 10 according to the fifth modification of the first embodiment exemplified in FIG. 11.

FIG. 38 is a schematic diagram illustrating the stack configuration according to the sixth modification of the sensor chip, and the analysis circuit 31 is added in the second layer in a stack configuration similar to that of the sensor chip 10 according to the sixth modification of the first embodiment exemplified in FIG. 12.

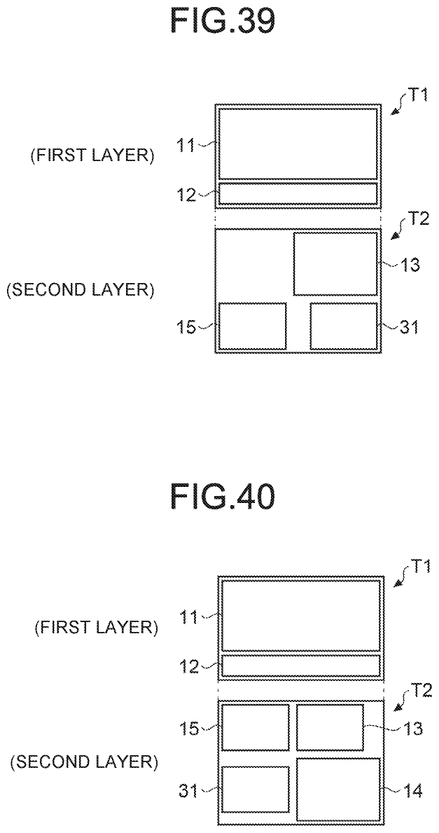

FIG. 39 is a schematic diagram illustrating the stack configuration according to the seventh modification of the sensor chip, and the analysis circuit 31 is added in the second layer in a stack configuration similar to that of the sensor chip 10 according to the seventh modification of the first embodiment exemplified in FIG. 13.

FIG. 40 is a schematic diagram illustrating the stack configuration according to the eighth modification of the sensor chip, and the analysis circuit 31 is added in the second layer in a stack configuration similar to that of the sensor chip 10 according to the eighth modification of the first embodiment exemplified in FIG. 14.

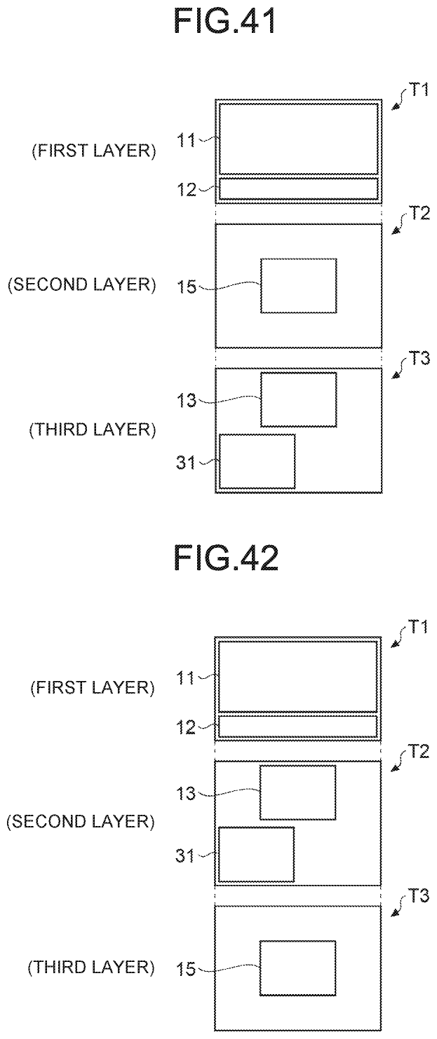

FIG. 41 is a schematic diagram illustrating the stack configuration according to the ninth modification of the sensor chip, and the analysis circuit 31 is added in the third layer in a stack configuration similar to that of the sensor chip 10 according to the ninth modification of the first embodiment exemplified in FIG. 15.

FIG. 42 is a schematic diagram illustrating the stack configuration according to the tenth modification of the sensor chip, and the analysis circuit 31 is added in the second layer in a stack configuration similar to that of the sensor chip 10 according to the tenth modification of the first embodiment exemplified in FIG. 16.

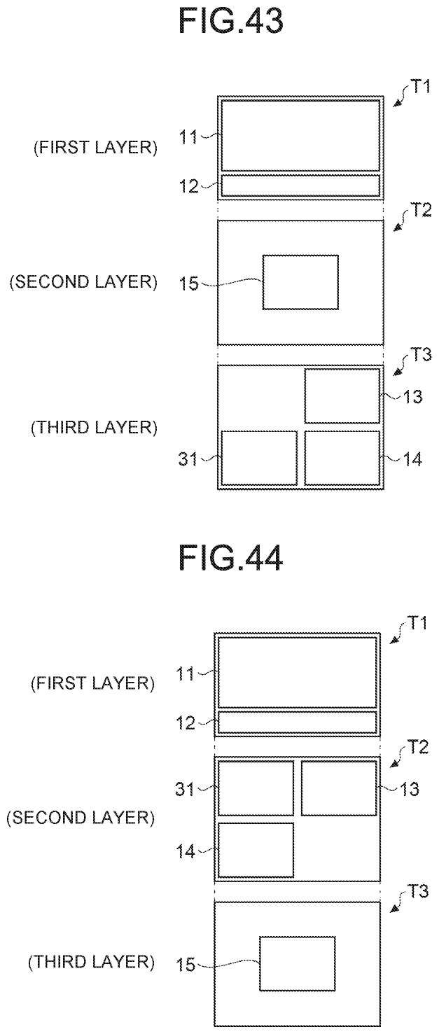

FIG. 43 is a schematic diagram illustrating the stack configuration according to the eleventh modification of the sensor chip, and the analysis circuit 31 is added in the third layer in a stack configuration similar to that of the sensor chip 10 according to the eleventh modification of the first embodiment exemplified in FIG. 17.

FIG. 44 is a schematic diagram illustrating a stack configuration according to the twelfth modification of the sensor chip, and the analysis circuit 31 is added in the second layer in a stack configuration similar to that of the sensor chip 10 according to the twelfth modification of the first embodiment exemplified in FIG. 18.

Note that, similarly to the first embodiment, in the present embodiment, the stack structure in which the light receiving section 11, the signal processing circuit 12, the flexible logic circuit 13, the main processor 14, and the memory 15 built in the separate chips 110, 120, 130, 140, and 150, respectively, are stacked is given as an example, however, the stack structure can be variously modified as in the above-described embodiments. For example, in a case where a device that does not require high-speed depth processing is the communication device 2, as described with reference to FIG. 6 in the first embodiment, the signal processing circuit 12, the main processor 14, the flexible logic circuit 13, and the memory 15 can be in a single chip 160. In this case, since the number of manufacturing steps or the bonding process of the chips 120 to 150 can be reduced, the manufacturing cost can be suppressed. Furthermore, depending on the application, the main processor 14 can be omitted from the chip 160 in FIG. 6.

4.3 DNN/CNN Analysis Process

Next, the machine learning processing executed by the analysis circuit 31 according to the present embodiment will be described with an example. Note that, in the following description, a case where the analysis circuit 31 executes analysis processing by a DNN and/or a CNN will be described with an example, however, it is not limited thereto, and the analysis circuit 31 may execute various kinds of analysis processing depending on a purpose.

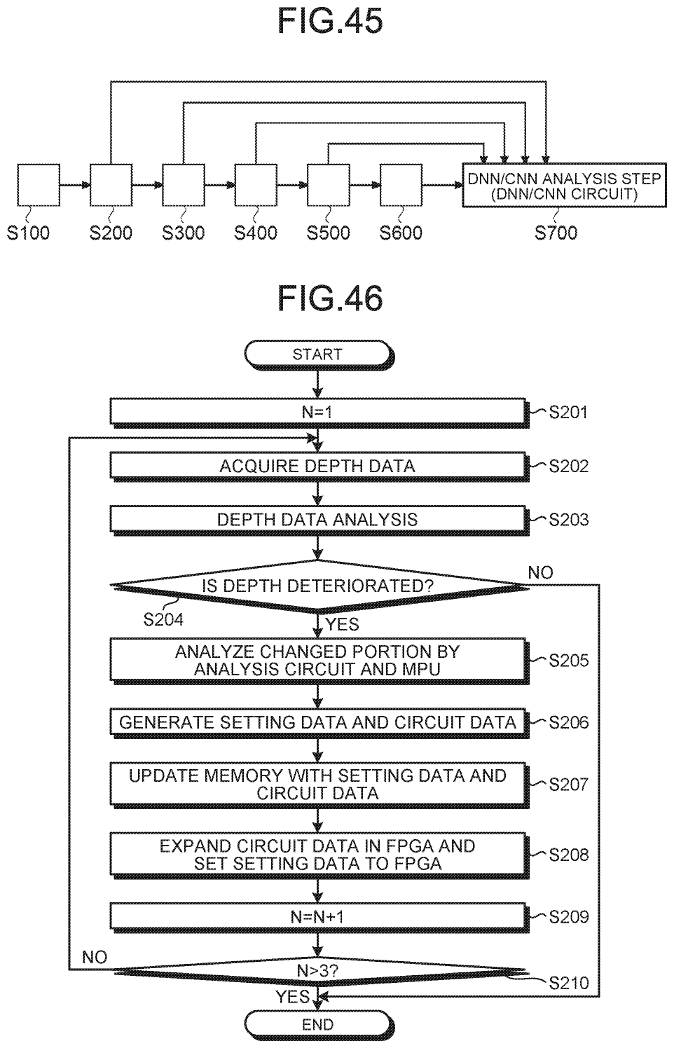

FIG. 45 is a diagram for describing an example of DNN/CNN analysis processing (machine learning processing) according to the present embodiment. As illustrated in FIG. 45, in a DNN/CNN analysis step S700, for example, out of the six steps of the photoelectric conversion step S100, the signal processing step S200, the phase conversion step S300, the calibration step S400, the control system step S500, and the filtering step S600 illustrated with reference to FIG. 21 in the first embodiment, the processing result of each of the signal processing step S200 to the filtering step S600 is given to an input layer. In the DNN/CNN analysis step S700, a learned model is created which causes setting data and/or circuit data optimal for reducing deterioration of depth data to appear in an output layer by deriving a weight for each of edges connecting nodes (also referred to as neurons) of respective layers from the input layer to the output layer via hidden layers.

By using the learned model created as described above, the analysis circuit 31 and/or the main processor 14 generates update data of setting data and/or circuit data optimal for reducing deterioration of the depth data and stores the created update data in the programmable memory space 152 of the memory 15.

4.4 Correction Process

Next, the operation when deterioration of the ranging sensor 100 is detected and corrected will be described in detail with a flowchart. FIG. 46 is a flowchart illustrating a schematic example of the operation according to the present embodiment.

As illustrated in FIG. 46, in this operation, first, the main processor 14 sets 1 to the value N for managing the number of repetitions of analysis (step S201). Then, with the signal processing circuit 12 being controlled, depth data is read from the light receiving section 11 (step S201).

Next, the main processor 14 and the flexible logic circuit 13 perform processing of the stages exemplified in FIG. 21 on the acquired depth data, input the results of the stages to the analysis circuit 31, and thereby analyze the depth data (step S203). Then, the main processor 14 determines whether or not there is deterioration in the depth performance on the basis of the analysis result (step S204).

If there is no deterioration in the depth performance (NO in step S204), the main processor 14 ends the operation. On the other hand, if there is deterioration in the depth performance (YES in step S204), the main processor 14 and the analysis circuit 31 analyze a portion that causes the deterioration in the depth performance in the ranging sensor 100 on the basis of the analysis result in step S203 (step S205) and generate new setting data and/or circuit data on the basis of the analysis result (step S206).

Next, the main processor 14 updates the setting data and/or the circuit data of the FPGA 131 stored in the programmable memory space 152 of the memory 15 with the setting data and/or the circuit data that has been generated (step S207) and changes the circuit configuration of the FPGA 131 by setting the updated setting data in the FPGA 131 and incorporating the updated circuit data in the FPGA 131 (step S208). Note that, in a case where setting data for the laser driver 18 that drives the light emitting sections 19, the actuator that drives the optical system of the light receiving section 11, or each component of the signal processing circuit 12 is updated, a predetermined parameter in the non-volatile memory 17 is updated with this setting data. As a result, driving of each component by the laser driver 18 or the actuator is adjusted.

Next, the main processor 14 increments the number of repetitions N by 1 (step S209) and determines whether or not the incremented value N is larger than a preset upper limit value of the number of repetitions (3 in this example) (step S210). If the number of repetitions N is equal to or less than the upper limit value (NO in step S210), the main processor 14 returns to step S202 and executes the subsequent operations again. On the other hand, if the number of repetitions N is larger than the upper limit value (YES in step S210), the main processor 14 ends this operation.

4.5 Action and Effects

As described above, according to the present embodiment, by incorporating the analysis circuit 31 on the communication device 2 side, it becomes possible to perform analysis of depth data to generation of update data on the basis of machine learning on the communication device 2 side. This makes it possible to acquire accurate depth data even in a case where the ranging sensor 100 is deteriorated.

Note that, in the present embodiment, the main processor 14 is not an essential component and may be omitted. In that case, various kinds of data processing may be executed by the flexible logic circuit 13 and the analysis circuit 31.

Other configurations, operations, and effects may be similar to those of the above-described embodiments, and thus detailed description is omitted here.

### 5. Fourth Embodiment

Note that the analysis circuit 31 according to the third embodiment may include an FPGA. In that case, the analysis circuit 31 may be implemented in the flexible logic circuit 13, for example. This makes it possible to reduce current consumption. Note that, in the following description, the similar components to those of the above-described embodiments are denoted by the same symbols, and redundant description thereof will be omitted.

5.1 Device Configuration

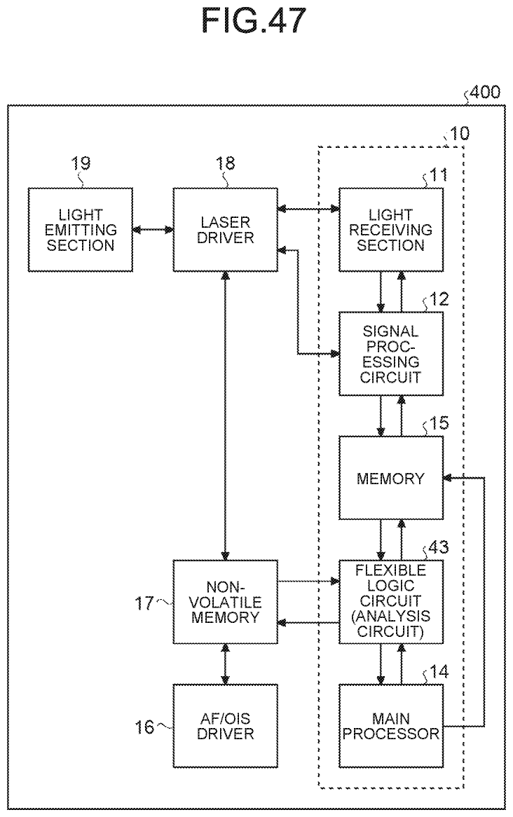

FIG. 47 is a block diagram illustrating a schematic configuration example of the ranging sensor according to the present embodiment. As illustrated in FIG. 47, a ranging sensor 400 in the communication device 2 according to the present embodiment has, for example, a configuration similar to that of the ranging sensor 300 described with reference to FIG. 32 in the third embodiment, in which the analysis circuit 31 is omitted, and the flexible logic circuit 13 is replaced with a flexible logic circuit 43 including the analysis circuit 31.

5.2 Stack Configuration Example of Sensor Chip

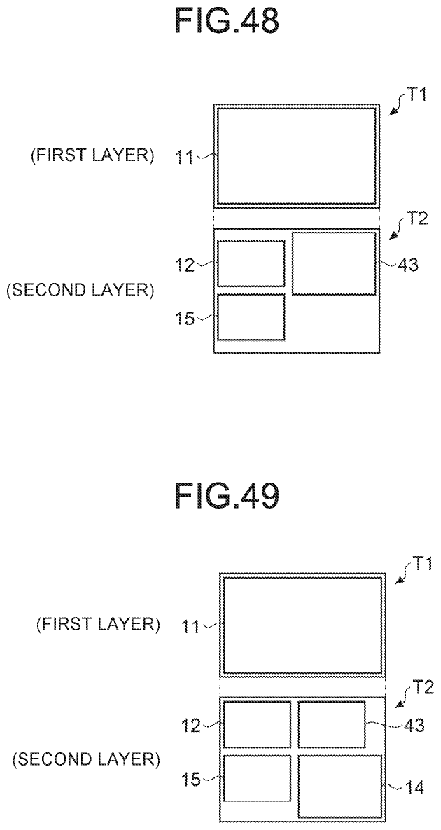

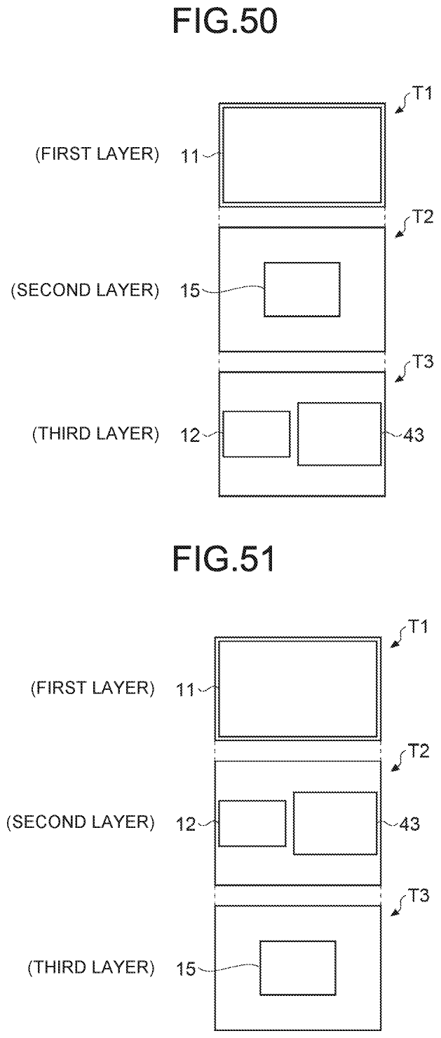

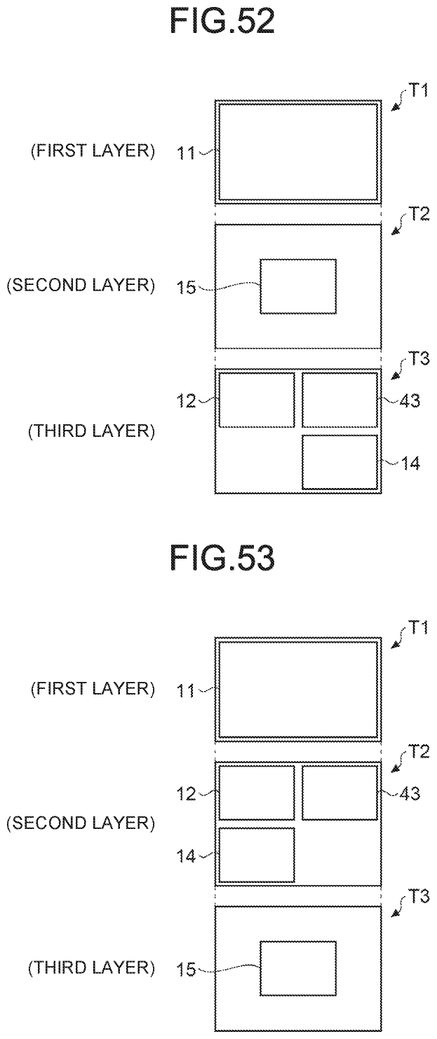

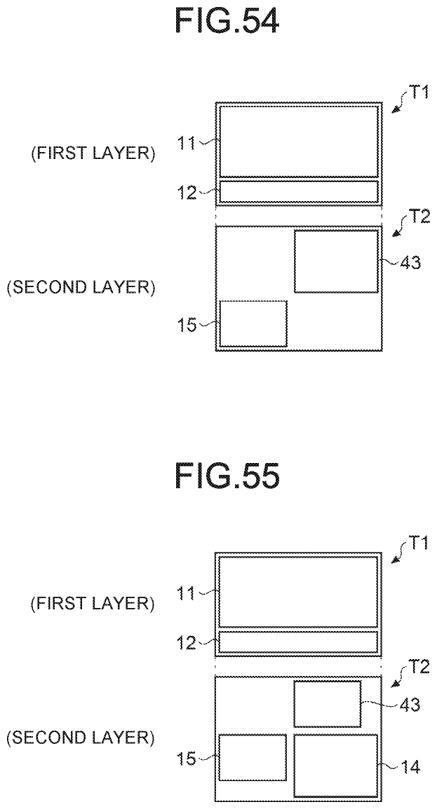

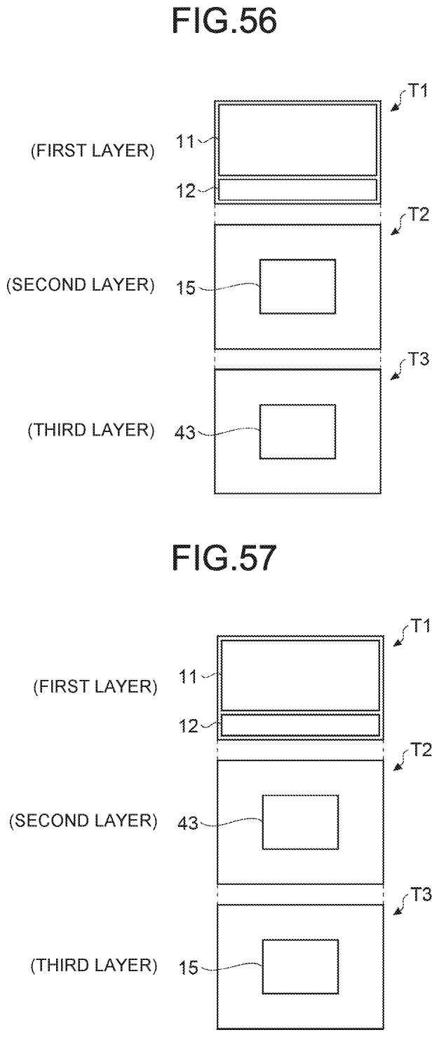

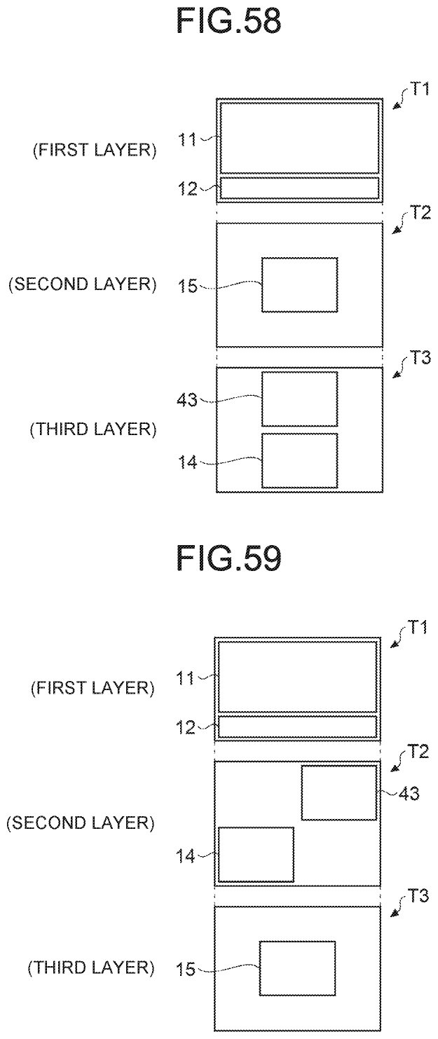

The stack configuration of the sensor chip 10 according to the present embodiment may be, for example, a configuration in which a flexible logic circuit 43 is built in the flexible logic chip 130 instead of the flexible logic circuit 13 in a configuration similar to the stack configuration described with reference to FIG. 3 in the third embodiment. Note that. without being limited thereto, for example, as illustrated in FIGS. 48 to 59, it is also possible to have a configuration in which the flexible logic circuit 13 in the stack configuration according to the first to twelfth modifications described using FIGS. 7 to 18, respectively, in the first embodiment is replaced with the flexible logic circuit 43.

Note that, similarly to the first embodiment, in the present embodiment, the stack structure in which the light receiving section 11, the signal processing circuit 12, the flexible logic circuit 43, the main processor 14, and the memory 15 built in the separate chips 110, 120, 130, 140, and 150, respectively, are stacked is given as an example, however, the stack structure can be variously modified as in the above-described embodiments. For example, in a case where a device that does not require high-speed depth processing is the communication device 2, as described with reference to FIG. 6 in the first embodiment, the signal processing circuit 12, the main processor 14, the flexible logic circuit 13, and the memory 15 can be in a single chip 160. In this case, since the number of manufacturing steps or the bonding process of the chips 120 to 150 can be reduced, the manufacturing cost can be suppressed. Furthermore, depending on the application, the main processor 14 can be omitted from the chip 160 in FIG. 6.

5.3 Action and Effects

As described above, according to the present embodiment, by incorporating the analysis circuit 31 in the flexible logic circuit 43, it becomes possible to perform analysis of depth data to generation of update data on the basis of machine learning on the communication device 2 side. As a result, adjustment at the time when the ranging sensor 400 is deteriorated can be performed with low current consumption.

Note that, in the present embodiment, the main processor 14 is not an essential component and may be omitted. In that case, various kinds of data processing may be executed by the flexible logic circuit 43.

Other configurations, operations, and effects may be similar to those of the above-described embodiments, and thus detailed description is omitted here.

### 6. Fifth Embodiment

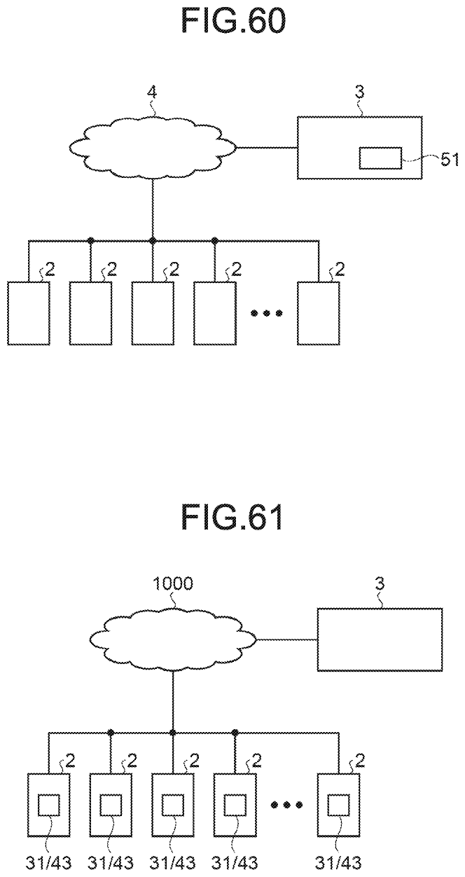

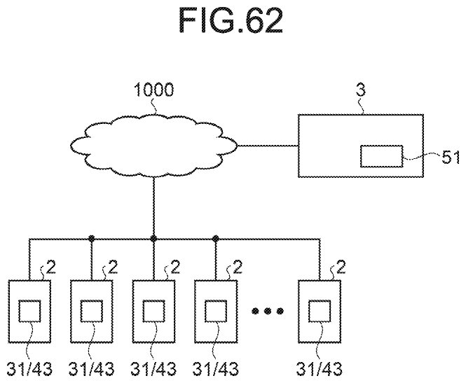

In the first and second embodiments described above, as illustrated in FIG. 60, an exemplary case has been described in which the analysis circuit 51 that executes analysis of depth performance and/or depth data (hereinafter, simply referred to as depth data or ranging information for simplification) up to generation of the update data is included in the server 3, and the server 3 side executes the analysis of the depth data up to the generation of the update data. Furthermore, in the third and fourth embodiments, as illustrated in FIG. 61, an exemplary case has been described in which the analysis circuit 31 or the flexible logic circuit 43 including the analysis circuit 31 is included in the communication device, and the communication device 2 side executes the analysis of the depth data up to the generation of the update data. However, the configuration for executing the analysis of the depth data up to the generation of the update data is not limited to one of the server 3 or the communication device 2. For example, as illustrated in FIG. 62, a configuration for executing the analysis of the depth data up to the generation of the update data can be selected from among the server 3 and communication devices 2.

Specifically, for example, in a case where a communication device 2 is a travelling device such as a drone, FA, an automobile, or an autonomous robot, it is also possible to configure so as to execute while switching as required such as that the communication device 2 performs the analysis of the depth data up to the generation of the update data during travelling and that the server 3 performs the analysis of the depth data up to the generation of the update data while the communication device 2 is stopped.

Alternatively, in the configuration exemplified in FIG. 62, it is also possible to configure so that a part of the processing from the analysis of the depth data to the generation of the update data is executed on the server 3 side and that the rest is executed on the communication device 2 side.

Switching whether at least a part of the processing from the analysis of the depth data to the generation of the update data is executed on the server 3 side or on the communication device 2 side may be executed by, for example, the main processor 14 or an application processor (switching section) (not illustrated).

As described above, according to the present embodiment, it is possible to change the circuit configuration implemented by the FPGA 131 in the analysis circuit 31 or 43, and thus by changing the circuit configuration of the sensor chip 10 depending on the application of the communication device 2, it is possible to support both the sensor system 1 (see FIG. 60) according to the first or second embodiment and the sensor system 1 (see FIG. 61) according to the third or fourth embodiment.

As a result, the following effects can be achieved.
Individual adjustment of image quality by each communication device 2 can be periodically performed
Current consumption can be reduced
It is possible to stably perform image processing of a specific work at high speed in a special environment specialized for a purpose.
It is possible to apply to various devices such as portable terminals such as smartphones and travelling devices such as automobiles.

Furthermore, in a case where the communication device 2 is a travelling device such as a drone, an automobile, or an autonomous robot, the following effects can be further achieved.

It is possible to design so as to execute while switching as required such as that the sensor chip 10 performs processing from analysis of image data to the generation of the update data during travelling and that the server 3 performs processing from the analysis of the image data to the generation of the update data while the communication device 2 is stopped.

It is possible to design so that a part of the processing from the analysis of the depth data to the generation of the update data is executed on the server 3 side and that the rest is executed on the communication device 2 side.

Other configurations, operations, and effects may be similar to those of the above-described embodiments, and thus detailed description is omitted here.

### 7. Use Cases

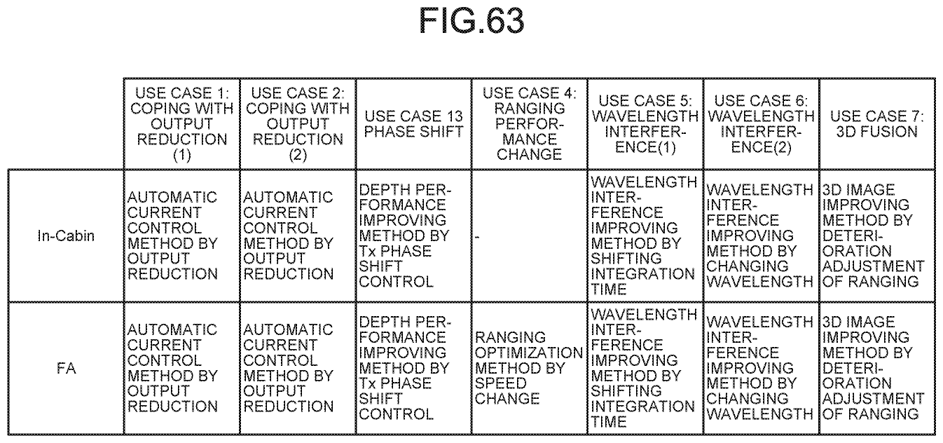

Next, use cases of the sensor systems 1 according to the above embodiments will be described with some examples. Note that, in the following description, an in-cabin monitoring system (hereinafter, referred to as ICM) and FA will be described as examples of use cases. FIG. 63 is a table summarizing use cases of the above embodiments in an ICM and use cases 1 to 7 of the above embodiments in FA. Hereinafter, each of the use cases in the table illustrated in FIG. 63 will be described in detail.

7.1 In-Cabin Monitoring System (ICM) Use Cases

First, use cases of an ICM listed in the upper part of FIG. 63 will be described. Note that, in the present use case, an exemplary case is described in which a wide-angle ranging device (corresponding to a communication device 2) on which the ranging sensors 100, 200, 300, or 400 (hereinafter, referred to as the ranging sensor 100 for simplification) according to the above-described embodiments is mounted is installed at the front mirror or the front ceiling of a vehicle AM, and the states of a driver and a passenger in the front seats are monitored. Note that monitoring of a passenger in a rear seat or an object placed on a rear seat (object detection in a case of an object) may also be performed by attaching, to the rear ceiling, a wide-angle ranging device (corresponding to another communication device 2) in which the ranging sensor 100 is mounted.

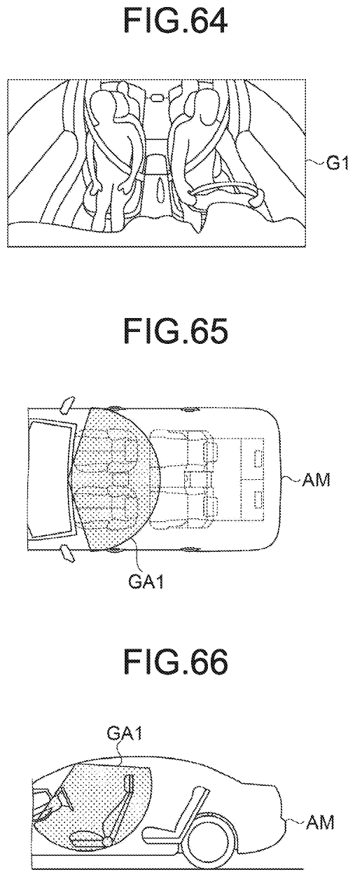

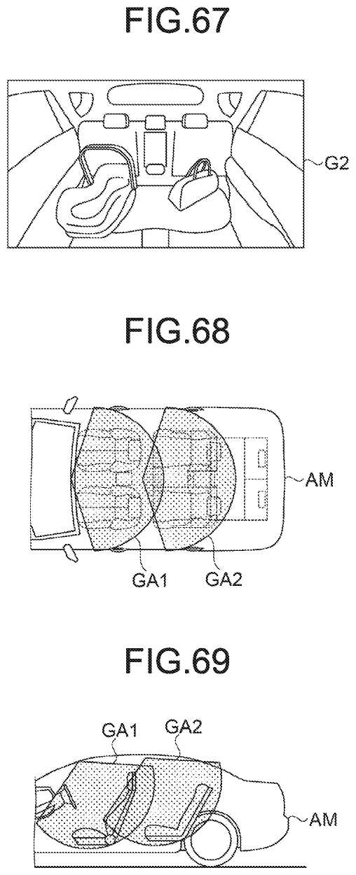

FIGS. 64 to 69 are diagrams for explaining use cases of the ICM, FIG. 64 is a diagram illustrating an example of a depth image G1 captured by a ranging device (corresponding to the communication device 2, hereinafter referred to as a front-row in-vehicle sensor) that monitors the front seats of the vehicle AM, FIG. 65 is a diagram illustrating a horizontal angle of view of the front-row in-vehicle sensor in FIG. 64, and FIG. 66 is a diagram illustrating a vertical angle of view of the front-row in-vehicle sensor in FIG. 64. In addition, FIG. 67 is a diagram illustrating an example of a depth image G2 captured by a rear row in-vehicle sensor (corresponding to the communication device 2) that monitors the rear seats of the vehicle AM. FIG. 68 is a diagram illustrating a horizontal angle of view of each of the front-row in-vehicle sensor in FIG. 67 and a rear-row in-vehicle sensor, and FIG. 69 is a diagram illustrating a vertical angle of view of each of the front-row in-vehicle sensor and the rear-row in-vehicle sensor in FIG. 67. Note that the example of the depth image captured by the front-row in-vehicle sensor in FIG. 67 may be similar to the depth image G1 illustrated in FIG. 64.

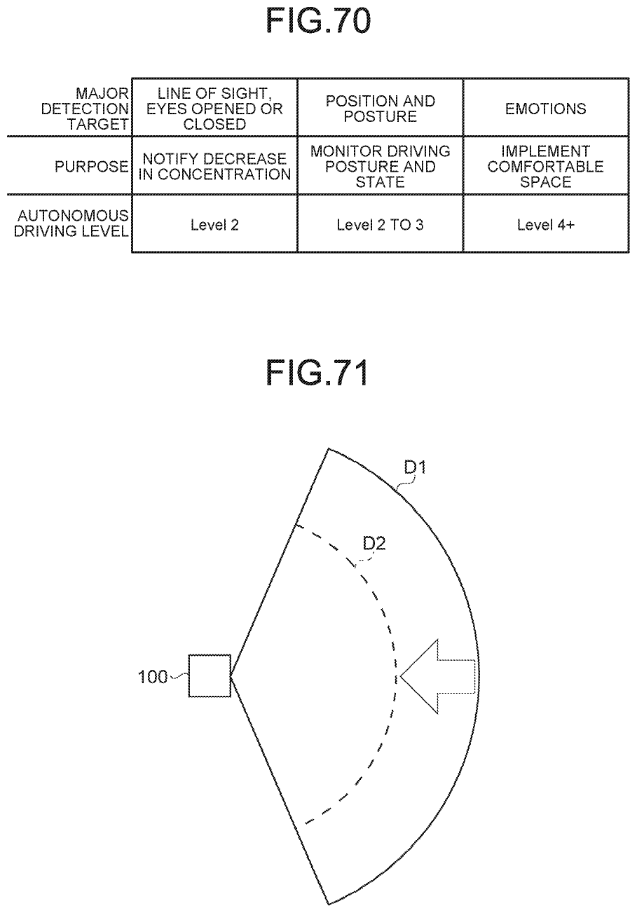

FIG. 70 is a table illustrating major detection targets and the purpose of the ICM for each autonomous driving level. For example, in level 2, detection of the facial expression of a driver, detection of parallax of the eyes, and confirmation of opening or closing of the eyes are executed in order to notify decreased focus of the driver. At levels 2 to 3, posture detection in which a driving posture or the state of the driver is monitored is executed. In level 4, emotion sensing or the like are performed in order to implement a comfortable space. In this manner, in autonomous driving, as the level increases, it is necessary to determine the state of the driver from various kinds of data based on human engineering without limiting to single piece of sensing data (for example, the line of sight or the like). As a result, it is possible to detect a human error and to suppress an accident.

7.1.1 Use Case 1

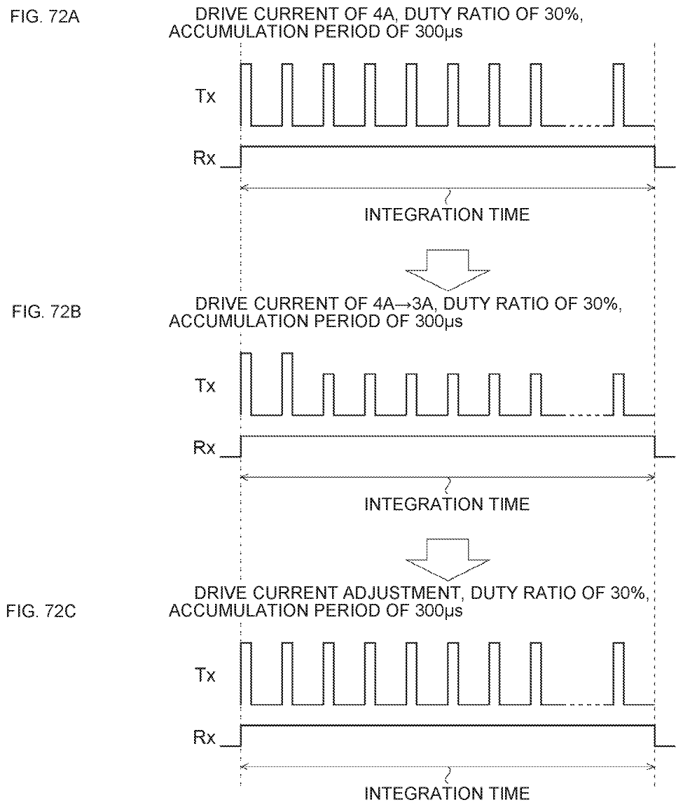

FIGS. 71 and 72 are diagrams for explaining use case 1 in the ICM. The use case 1 exemplifies an automatic control method in a case where the output of the light emitting sections 19 in the ranging sensor 100 decreases and the upper limit value of the drive current of the light emitting sections 19 has a margin.

FIG. 71 is a schematic diagram illustrating an example of a detection range of the ranging sensor. FIG. 72 includes timing charts each illustrating a relationship between a pulse waveform of the irradiation light output from the light emitting section (Tx) and the accumulation period of the light receiving section (Rx), in which (a) is a timing chart at the normal time, (b) is a timing chart when the output of the light emitting section 19 decreases, and (c) is a timing chart after the output adjustment of the light emitting section 19 according to the present disclosure.

In addition, FIG. 72 illustrates an exemplary case where the light emitting section 19 is driven with the drive current at the normal time being 4 A (amperes) and the duty ratio of the irradiation light L1 being 30%, and the light receiving section 11 is driven with the accumulation period being 300 μs (microseconds).

As illustrated in FIG. 71, for example, in a case where the output of the light emitting sections 19 decreases for some reason, a detection range D1 of the ranging sensor 100 changes to a detection range D2 having a shorter distance. As a result, as illustrated in (a) to (b) of FIG. 72, the pulse intensity of the irradiation light L1 after the output reduction decreases. As a result, the depth noise, the depth error, and the like increase, and the SN ratio is deteriorated, and thus, there is a possibility that detection accuracy of face authentication, gesture authentication, posture detection, emotion sensing, and the like is deteriorated.

Therefore, in the present use case, since there is a margin in the upper limit value of the driving current of the light emitting section 19, a parameter for driving the laser driver 18 stored in the non-volatile memory 17 is updated so as to increase the current setting of the light emitting section 19 by using the method according to the above-described embodiment. As a result, as illustrated in (c) of FIG. 72, it is possible to correct the pulse intensity of the irradiation light L1 output from the light emitting section 19 to a normal value.

Note that, in a case where the light emitting section 19 has a structure in which a plurality of light emitting elements is arrayed in a two-dimensional lattice shape, and a decrease in output occurs due to deterioration or the like in a part of the array plane, update data may be generated so that an area in which the output in the laser driver 18 has decreased is specified from the depth data from the depth data and that a parameter for a drive circuit corresponding to the specified area is adjusted.

7.1.2 Use Case 2

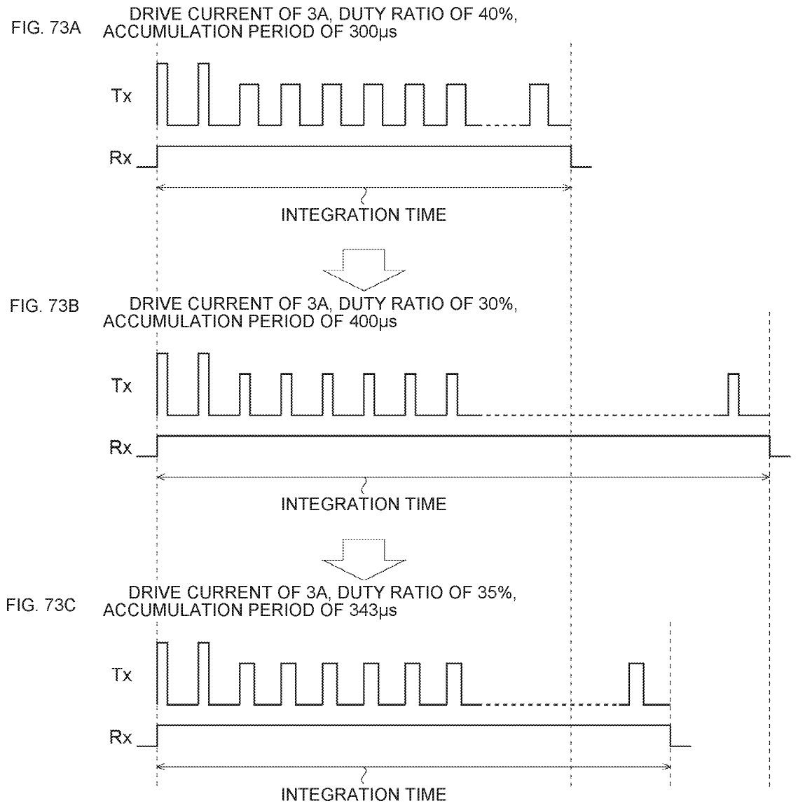

FIG. 73 is a diagram for describing use case 2 in the ICM. The use case 2 exemplifies the automatic control method in a case where the output of the light emitting sections 19 in the ranging sensor 100 decreases and the upper limit value of the drive current of the light emitting sections 19 has no margin.

FIG. 73 includes timing charts each illustrating a relationship between a pulse waveform of the irradiation light output from the light emitting section and the accumulation period of the light receiving section, in which (a) is a timing chart in a case where the detection accuracy is maintained by adjusting the duty ratio (that is, the duty ratio of the irradiation light L1) of the light emitting section 19, (b) is a timing chart in a case where the detection accuracy is maintained by adjusting the accumulation period of the light receiving section 11, and (c) is a timing chart in a case where the detection accuracy is maintained by adjusting the duty ratio of the light emitting section 19 and the accumulation period of the light receiving section 11. Note that the detection range of the ranging sensor 100 may be similar to the detection range D1 or D2 illustrated in FIG. 71.

As illustrated in (a) to (c) of FIG. 73, in a case where there is no margin in the upper limit value of the driving current of the light emitting section 19, parameters for driving the laser driver 18 and the sensor chip 10 stored in the non-volatile memory 17 are updated so as to adjust one or both of the duty ratio of the light emitting section 19 and the accumulation period of the light receiving section 11. As a result, it is possible to adjust the ranging sensor 100 so as to maintain the detection accuracy.

Note that, in a case where the light emitting section 19 has a structure in which a plurality of light emitting elements is arrayed in a two-dimensional lattice shape, and a decrease in output occurs due to deterioration or the like in a part of the array plane, similarly to the use case 1, update data may be generated so that an area in which the output in the laser driver 18 has decreased is specified from the depth data from the depth data and that a parameter for a drive circuit corresponding to the specified area is adjusted.

7.1.3 Use Case 3

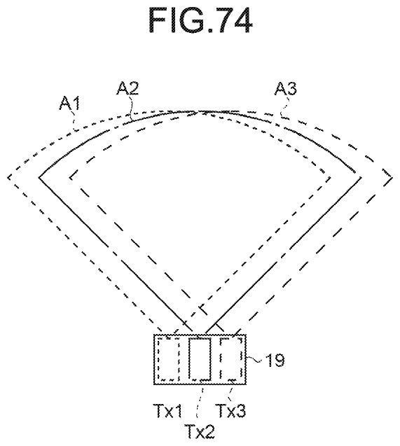

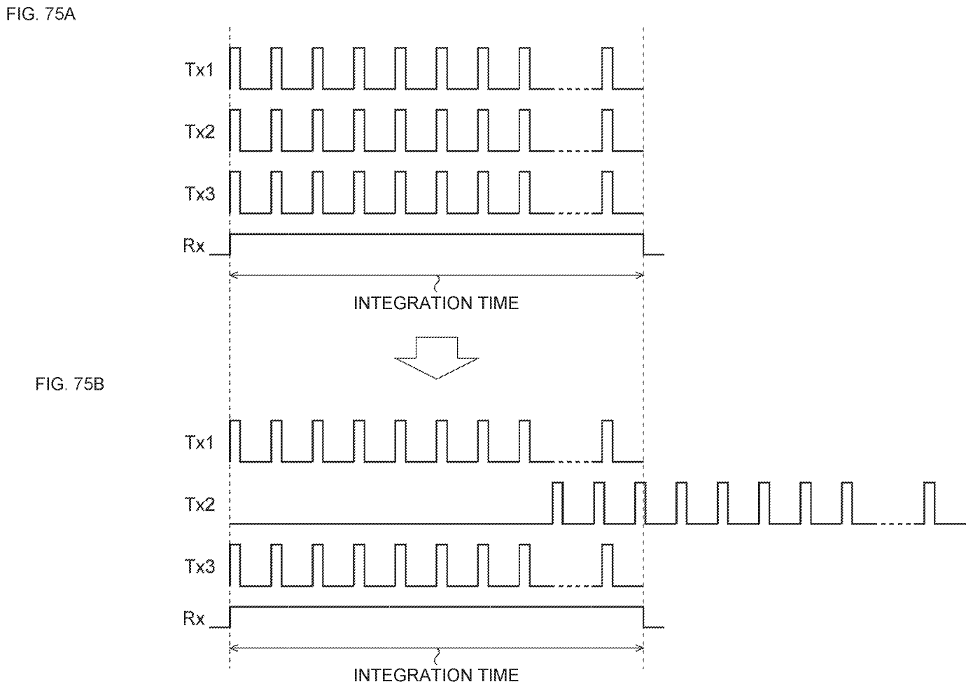

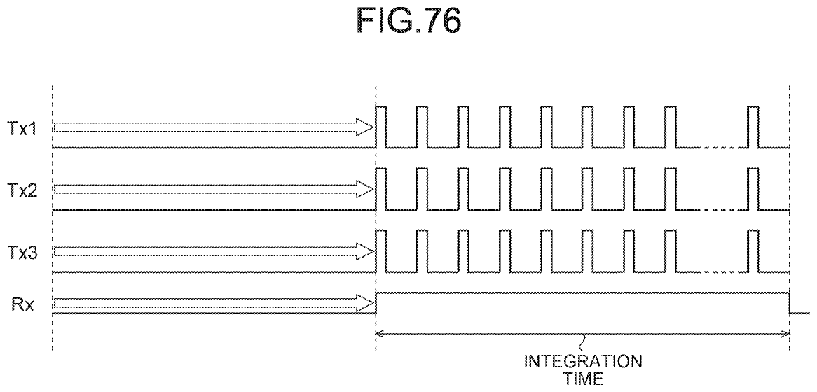

FIGS. 74 to 76 are diagrams for describing use case 3 in the ICM. The use case 3 illustrates an automatic depth performance improving method by phase shift control in a case where the light emitting section 19 includes a plurality of light sources and the light emission timing (phase) is shifted between the plurality of light sources.

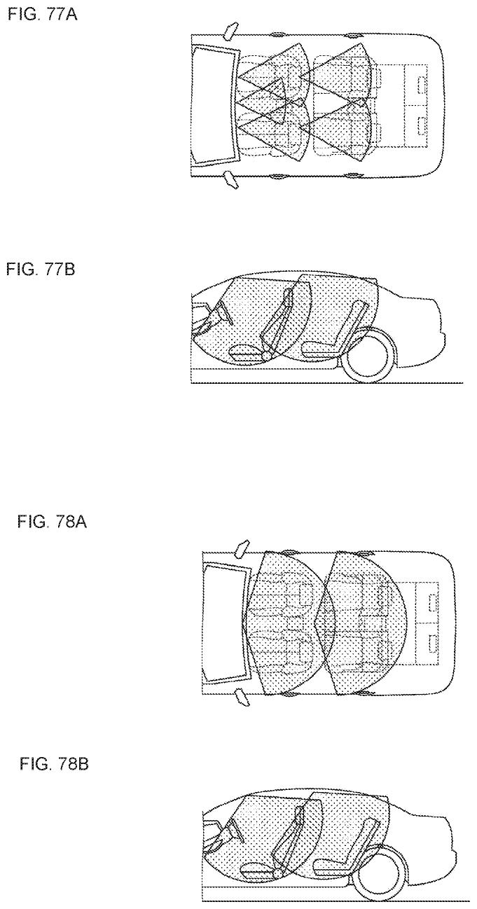

FIG. 74 is a schematic diagram illustrating an example of irradiation ranges of a plurality of light sources included in the light emitting section. FIGS. 75 and 76 are timing charts illustrating the relationship between the pulse waveform of the irradiation light output from a plurality of light sources (Tx1 to Tx3) of the light emitting section and the accumulation period of the light receiving section (Rx), in which (a) of FIG. 75 is a timing chart at the normal time, (b) is a timing chart in a case where the phase of one light source Tx2 among the plurality of light sources Tx1 to Tx3 is shifted, and FIG. 76 illustrates a timing chart after phase adjustment of the light emitting section 19 according to the present disclosure.

As illustrated in FIGS. 74 and (a) of 75, the plurality of light sources Tx1 to Tx3 of the light emitting section 19 irradiate overlapping irradiation areas A1 to A3, respectively, with the irradiation light L1 having the same phase. In this state, as illustrated in (b) of FIG. 75, in a case where a phase shift occurs partially in the light source Tx2 due to an influence of deterioration in the configuration from the light emitting section 19 to the laser driver 18 (including an influence of a flexible connection portion connecting the light emitting section 19 and the laser driver 18), in the present disclosure, which light source has the phase shift is specified from the area where the amount of light is attenuated by analyzing the depth data. For example, in a case where the light source Tx2 has the phase shift, parameters stored in the non-volatile memory 17 are updated so that the phases of the other light sources Tx1 and Tx3 are delayed so as to match the phase of the light source Tx2 and that the accumulation period of the light receiving section 11 is delayed so as to match the phase of each of the light sources Tx1 to Tx3. As a result, the phases of all the light sources Tx1 to Tx3 of the light emitting section 19 can be aligned, and thus in-plane ranging performance and depth performance can be improved.

7.1.4 Use Case 5

FIGS. 77 to 80 are diagrams for describing use case 5 in the ICM. The use case 5 illustrates an automatic control method for suppressing interference in a case where a plurality of ICMs interferes with each other or an ICM interferes with another in-vehicle system (for example, a driving monitoring system or the like), and the plurality of ICMs or the ICM and the other in-vehicle system, which are causing the interference, use irradiation light in an overlapping wavelength band. Note that, in FIGS. 77 to 79, a fan-shaped dotted area with dots indicates an irradiation area of irradiation light of an ICM and another in-vehicle system.

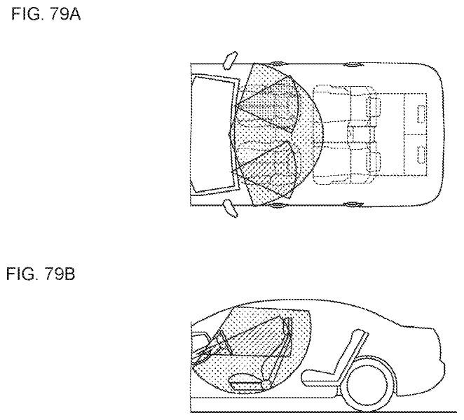

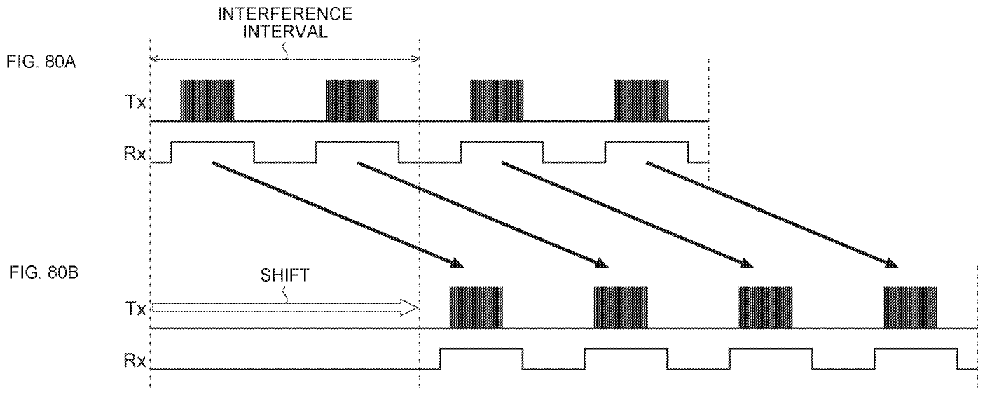

FIGS. 77 and 78 are diagrams illustrating an exemplary case where the irradiation areas overlap between a plurality of ICMs, and FIG. 79 is a diagram illustrating an exemplary case where irradiation areas overlap between an ICM and another in-vehicle system. As illustrated in FIGS. 77 to 79, in a case where the irradiation areas of the irradiation light overlap with each other, when the light emission timing overlap with each other, an interference interval occurs in which the irradiation light interferes with that of another ICM or another in-vehicle system as illustrated in (a) of FIG. 80.

Therefore, in the present disclosure, as illustrated in (b) of FIG. 80, in a case where it is found from a depth performance analysis result obtained by analyzing depth data that the depth performance of at least a part of the plane has been deteriorated due to the influence of interference, a parameter stored in the non-volatile memory 17 is updated so as to shift the light emission period of the light emitting section 19. This makes it possible to suppress occurrence of interference between a plurality of ICMs or an ICM and another in-vehicle system.

7.1.5 Use Case 6

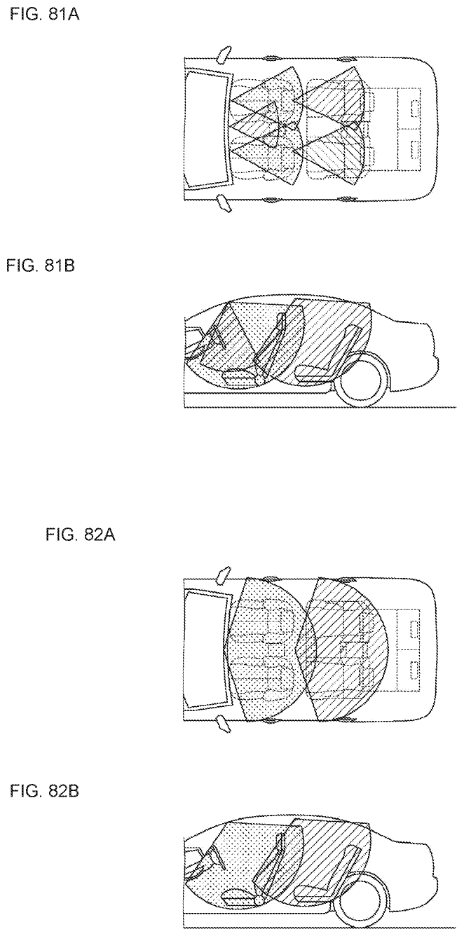

FIGS. 81 to 83 are diagrams for describing use case 6 in the ICM. Similarly to the use case 5, the use case 6 illustrates an automatic control method for suppressing interference in a case where a plurality of ICMs interferes with each other or an ICM interferes with another in-vehicle system (for example, a driving monitoring system or the like), and the plurality of ICMs or the ICM and the other in-vehicle system, which are causing the interference, use irradiation light in an overlapping wavelength band. However, in the use case 6, at least the ICM according to the present disclosure has a wavelength changing function for irradiation light.

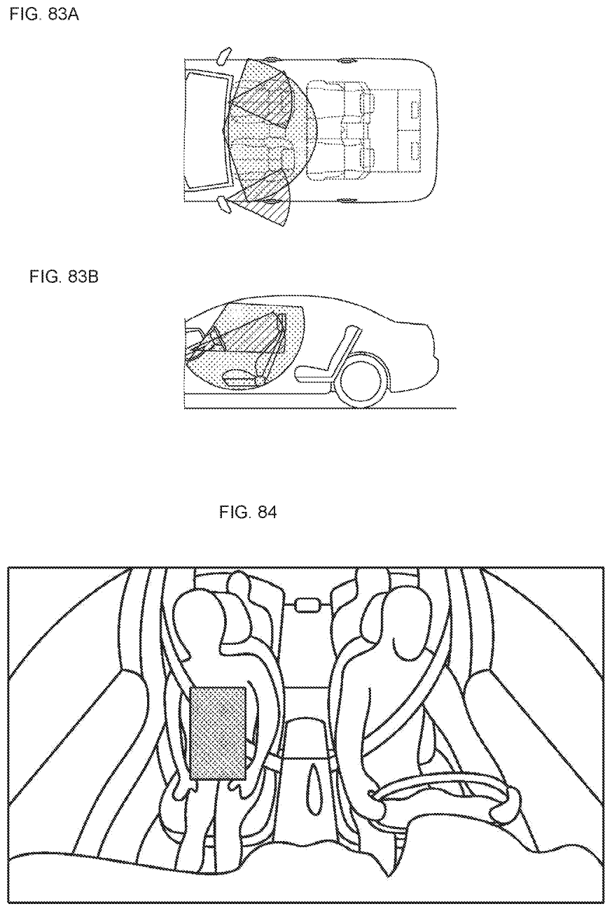

FIGS. 81 and 82 are diagrams illustrating an exemplary case where the irradiation areas overlap between a plurality of ICMs, and FIG. 83 is a diagram illustrating an exemplary case where irradiation areas overlap between an ICM and another in-vehicle system. In FIGS. 81 to 83, it is based on the premise that a fan-shaped dotted area is irradiated with irradiation light of a first wavelength (for example, 940 nm) and that a hatched area is irradiated with irradiation light of a second wavelength (for example, 850 nm) that is different from the first wavelength.

As illustrated in FIGS. 81 to 83, in a case where it is found from the depth performance analysis result obtained by analyzing the depth data that the depth performance of at least a part of the plane has been deteriorated due to an influence of interference, a parameter stored in the non-volatile memory 17 is updated so that the irradiation light L1 output from the light emitting section 19 to the irradiation light L1 of another wavelength band with which no interference occurs or the degree of interference is small. This makes it possible to suppress occurrence of interference between a plurality of ICMs or an ICM and another in-vehicle system.

Note that, by combining use case 5 and use case 6 described above, it is possible to accurately suppress occurrence of interference even in a case where more complicated interference occurs.

7.1.6 Use Case 7

FIGS. 84 and 85 are diagrams for describing use case 7 in the ICM. In the use case 7, 3D fusion for acquiring a three-dimensional color image by combining the ranging sensor 100 and an image sensor capable of acquiring the color image will be described. In FIGS. 84 and 85, it is based on the premise that a hatched rectangular area is not given with accurate depth information.

As illustrated in FIGS. 84 and 85, for example, in a case where a part of the image in the plane is not displayed well due to deterioration of the depth performance of the ranging sensor 100, it is possible to automatically improve the three-dimensional color image acquired by 3D fusion by updating a parameter stored in the non-volatile memory 17 on the basis of the depth performance analysis result obtained by analyzing the depth data. In addition, when deterioration or failure of at least a part of the ranging sensor 100 is found from analysis, it is possible to automatically improve or repair the ranging sensor 100 by changing and correcting the FPGA 131 by the flexible logic circuit 13.

In addition, the use case 7 can also be applied to creation of a three-dimensional image in order to perform detection of the facial expression of the driver, detection of parallax of the eyes, confirmation of opening or closing of the eyes, posture detection in which a driving posture or the state of the driver is monitored at levels 2 to 3, emotion sensing for implementing a comfortable space at level 4, and the like. In this case, similarly to FIG. 84 or 85, in a case where a part of the image in the plane is disturbed due to deterioration of the depth performance of the ranging sensor 100, it is possible to automatically improve a generated three-dimensional image by updating a parameter stored in the non-volatile memory 17 on the basis of a depth performance analysis result obtained by analyzing the depth data. In addition, when deterioration or failure of at least a part of the ranging sensor 100 is found from analysis, it is possible to automatically improve or repair the ranging sensor 100 by changing and correcting the FPGA 131 by the flexible logic circuit 13.

7.2 Use Case of FA

Next, the use cases of FA illustrated in the lower part of FIG. 63 will be described. Note that, in the present use case, an exemplary case is described in which a wide-angle ranging device (corresponding to the communication device 2) on which the ranging sensor 100, 200, 300, or 400 (hereinafter referred to as the ranging sensor 100 for simplification) according to the above-described embodiments is attached as the eyes of an FA transfer robot, and the FA transfer robot self-travels while monitoring obstacles in an area such as a factory. Note that a plurality of the light emitting sections 19 in the ranging sensor 100 may be included depending on the application or others.

7.2.1 Use Case 1

The use case 1 exemplifies an automatic control method in a case where the output of the light emitting sections 19 in the ranging sensor 100 decreases and the upper limit value of the drive current of the light emitting sections 19 has a margin. In this case, similarly to the use case 1 of the ICM, since there is a margin in the upper limit value of the driving current of the light emitting section 19, a parameter for driving the laser driver 18 stored in the non-volatile memory 17 is updated so as to increase the current setting of the light emitting section 19 by using the method according to the above-described embodiment. As a result, it is possible to correct the pulse intensity of the irradiation light L1 output from the light emitting section 19 to a normal value.

7.2.2 Use Case 2

The use case 2 exemplifies the automatic control method in a case where the output of the light emitting sections 19 in the ranging sensor 100 decreases and the upper limit value of the drive current of the light emitting sections 19 has no margin. In this case, similarly to the use case 2 of the ICM, parameters for driving the laser driver 18 and the sensor chip 10 stored in the non-volatile memory 17 are updated so as to adjust one or both of the duty ratio of the light emitting section 19 and the accumulation period of the light receiving section 11. As a result, it is possible to adjust the ranging sensor 100 so as to maintain the detection accuracy.

7.2.3 Use Case 3

The use case 3 illustrates an example of an automatic depth performance improving method by phase shift control in a case where the light emitting section 19 includes a plurality of light sources and the light emission timing (phase) is shifted between the plurality of light sources. In this case, similarly to the use case 3 of the ICM, by analyzing the depth data, which light source has the phase shift is specified from an area where the amount of light is attenuated. For example, in a case where the light source Tx2 has the phase shift, parameters stored in the non-volatile memory 17 are updated so that the phases of the other light sources Tx1 and Tx2 are delayed so as to match the phase of the light source Tx2 and that the accumulation period of the light receiving section 11 is delayed so as to match the phase of each of the light sources Tx1 to Tx3. As a result, the phases of all the light sources Tx1 to Tx3 of the light emitting section 19 can be aligned, and thus in-plane ranging performance and depth performance can be improved.

7.2.4 Use Case 4

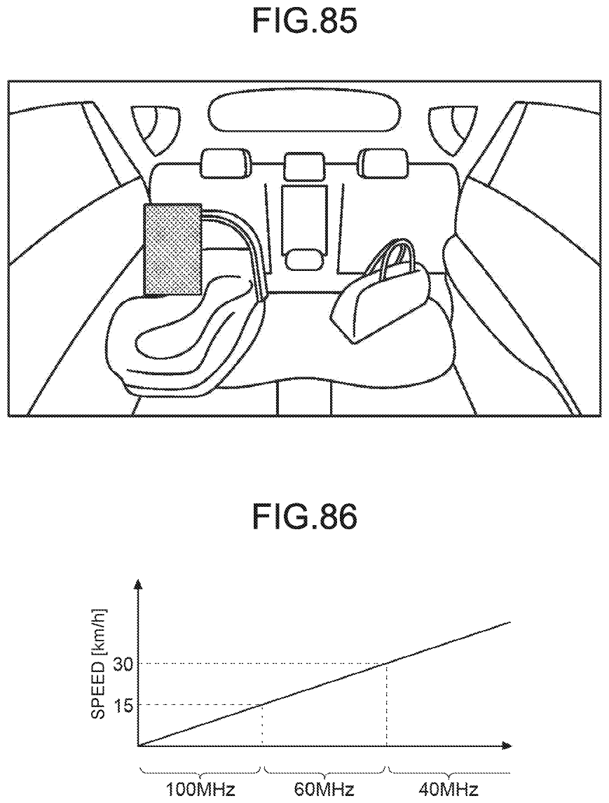

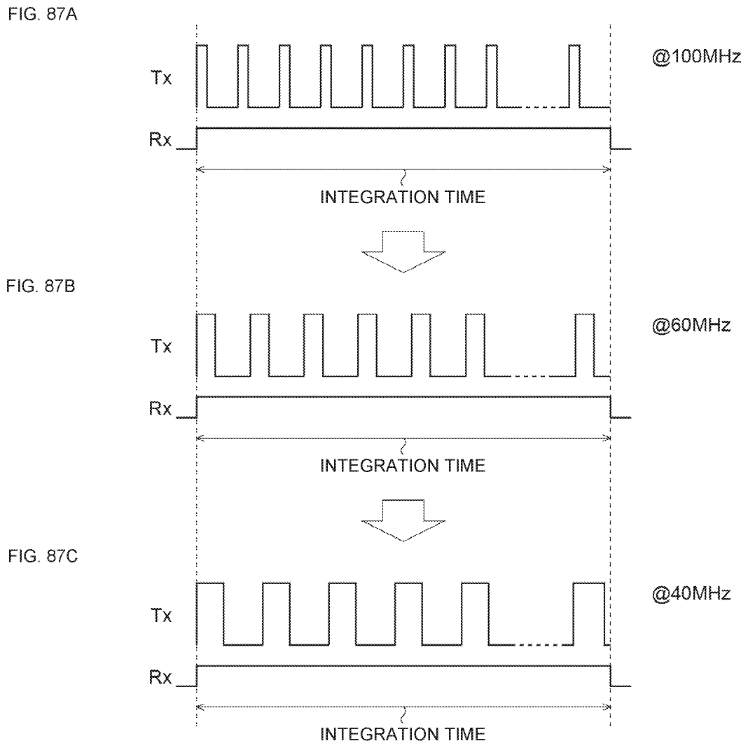

FIGS. 86 and 87 are graphs for describing use case 4 in the FA. In the use case 4, automatic change of ranging performance accompanied by speeding up of an FA transfer robot will be described. When the FA transfer robot increases the speed, it is necessary to expand an obstacle detection area, and thus it is necessary to increase the detection distance by the ranging sensor 100. Therefore, in the present disclosure, the current speed of the FA transfer robot is recognized from the depth data, and in a case where the current speed is equal to or higher than a predetermined speed that has been set in advance, a light emission cycle (frequency) of the light emitting section 19 is reduced, and the ranging distance is increased. As an example, as illustrated in FIGS. 86 and 87, parameters stored in the non-volatile memory 17 are updated so that, for example, the light emitting section 19 is driven at 100 MHz with a ranging range of 1.5 m in a case where the speed of the FA transfer robot is less than 15 km/h, that the ranging distance is 2.5 m in a case where the speed is equal to or faster than 15 km/h and less than 30 km/h, and that the light emitting section is driven at 40 MHz with a ranging distance of 3.75 m in a case where the speed is equal to or faster than 30 km/h. As a result, it is possible to automatically adjust the ranging distance depending on the speed of the FA transfer robot, and thus it is possible to suppress collision with an obstacle or the like.

7.2.5 Use Case 5

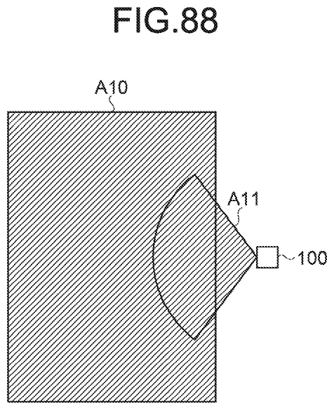

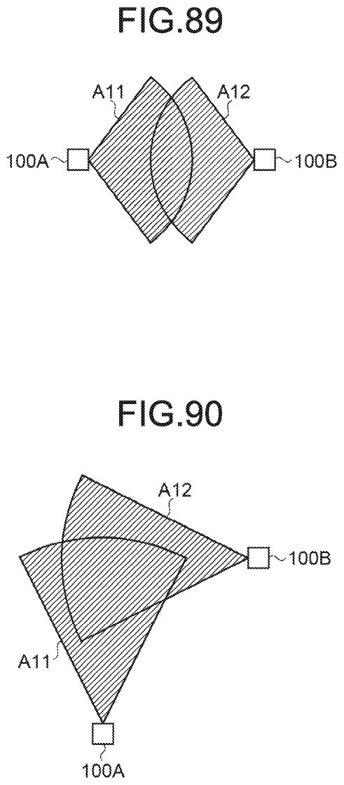

FIGS. 88 to 90 are diagrams for explaining use case 5 in the FA. The use case 5 illustrates an automatic control method for suppressing interference in a case where a plurality of FA transfer robots interferes with each other or an FA transfer robot interferes with another monitoring system (for example, an area monitoring system or the like), and the plurality of FA transfer robots or the FA transfer robot and the other monitoring system, which are causing the interference, use irradiation light in an overlapping wavelength band. Note that, in FIGS. 88 to 90, a fan-shaped hatched area indicates an irradiation area of irradiation light of an FA transfer robot and another monitoring system.

In such a case, similarly to the use case 5 of the ICM, a parameter stored in the non-volatile memory 17 is updated so as to shift the light emission period of the light emitting section 19. This makes it possible to suppress occurrence of interference between the plurality of FA transfer robots or a FA transfer robot and another monitoring system.

7.2.6 Use Case 6

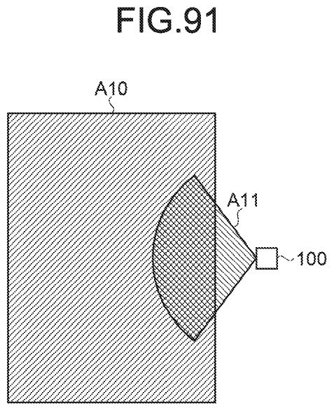

FIGS. 91 to 93 are diagrams for explaining use case 6 in the FA. Similarly to the use case 5, the use case 6 illustrates an automatic control method for suppressing interference in a case where a plurality of FA transfer robots interferes with each other or an FA transfer robot interferes with another monitoring system (for example, an area monitoring system or the like), and the plurality of FA transfer robots or the FA transfer robot and the other monitoring system, which are causing the interference, use irradiation light in an overlapping wavelength band. However, in the use case 6, at least the FA transfer robot according to the present disclosure has a wavelength changing function for irradiation light.

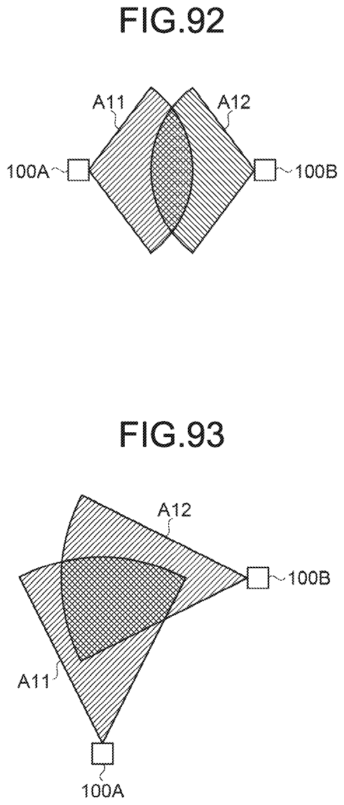

FIGS. 91 to 92 illustrates an exemplary case where the irradiation areas overlap each other between a plurality of FA transfer robots, and FIG. 93 illustrates an exemplary case where the irradiation areas overlap each other between an FA transfer robot and another monitoring system. In FIGS. 91 to 93, it is based on the premise that a fan-shaped hatched area with left oblique lines is irradiated with irradiation light of the first wavelength (for example, 940 nm) and that a hatched area with right oblique lines is irradiated with irradiation light of the second wavelength (for example, 850 nm) that is different from the first wavelength.

In such a case, similarly to the use case 6 of the ICM, parameters stored in the non-volatile memory 17 are updated so that the irradiation light L1 output from the light emitting section 19 is changed to the irradiation light L1 of another wavelength band that does not cause interference or cause interference of a small degree. This makes it possible to suppress occurrence of interference between the plurality of FA transfer robots or a FA transfer robot and another monitoring system.

7.2.7 Use Case 7

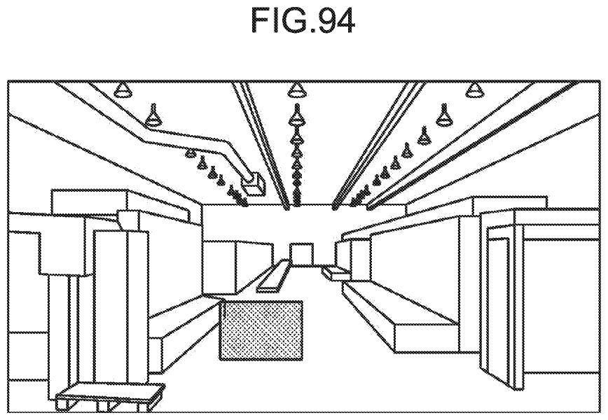

FIG. 94 is a diagram for describing use case 7 in the FA. In the use case 7, 3D fusion for acquiring a three-dimensional color image by combining the ranging sensor 100 and an image sensor capable of acquiring the color image will be described. In FIG. 94, it is based on the premise that a filled rectangular area is an area to which accurate depth information is not given.

As illustrated in FIG. 94, for example, in a case where a part of the image in the plane is not displayed well due to deterioration of the depth performance of the ranging sensor 100, similarly to the use case 7 of the ICM, it is possible to automatically improve the three-dimensional color image acquired by 3D fusion by updating a parameter stored in the non-volatile memory 17 on the basis of the depth performance analysis result obtained by analyzing the depth data. In addition, when deterioration or failure of at least a part of the ranging sensor 100 is found from analysis, it is possible to automatically improve or repair the ranging sensor 100 by changing and correcting the FPGA 131 by the flexible logic circuit 13.

In addition, the use case 7 in the FA can also be applied to creation of a three-dimensional image in order to perform object detection on depth data. In this case, similarly to the use case 7 of the ICM, in a case where a part of the image in the plane is disturbed due to deterioration of the depth performance of the ranging sensor 100, it is possible to automatically improve a generated three-dimensional image by updating a parameter stored in the non-volatile memory 17 on the basis of a depth performance analysis result obtained by analyzing the depth data. In addition, when deterioration or failure of at least a part of the ranging sensor 100 is found from analysis, it is possible to automatically improve or repair the ranging sensor 100 by changing and correcting the FPGA 131 by the flexible logic circuit 13.

### 8. Application Example

The technology according to the present disclosure can be applied to various products. For example, the technology according to the present disclosure may be implemented as a device to be mounted on a traveling body of any type such as automobiles, electric vehicles, hybrid electric vehicles, motorcycles, bicycles, personal mobilities, airplanes, drones, ships, robots, construction machines, or agricultural machines (tractors).

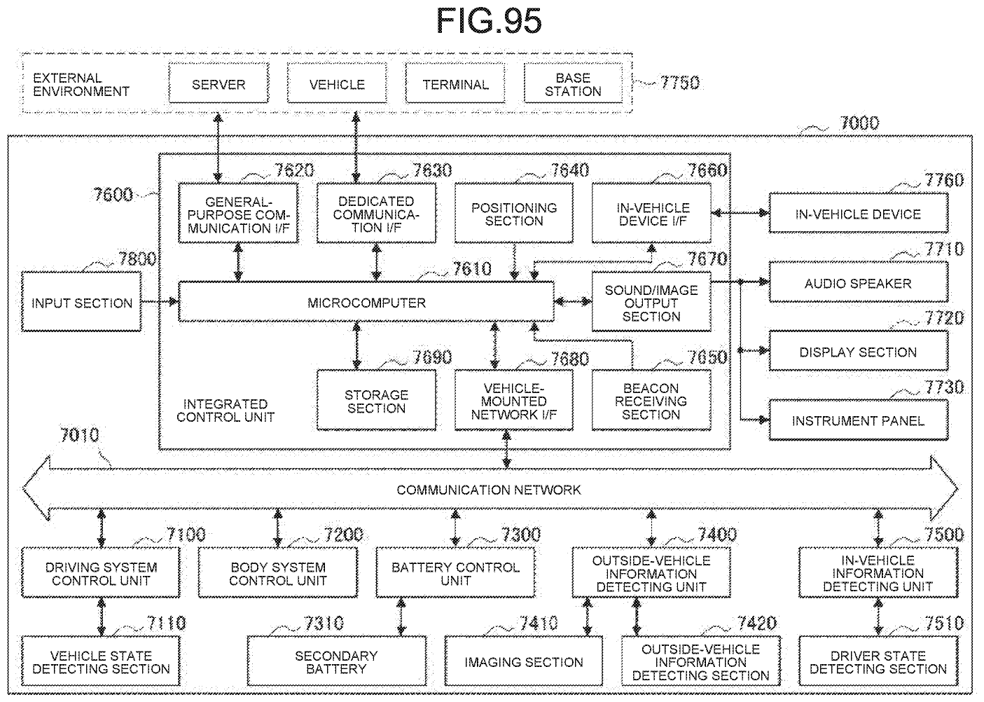

FIG. 95 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 95, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 95 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

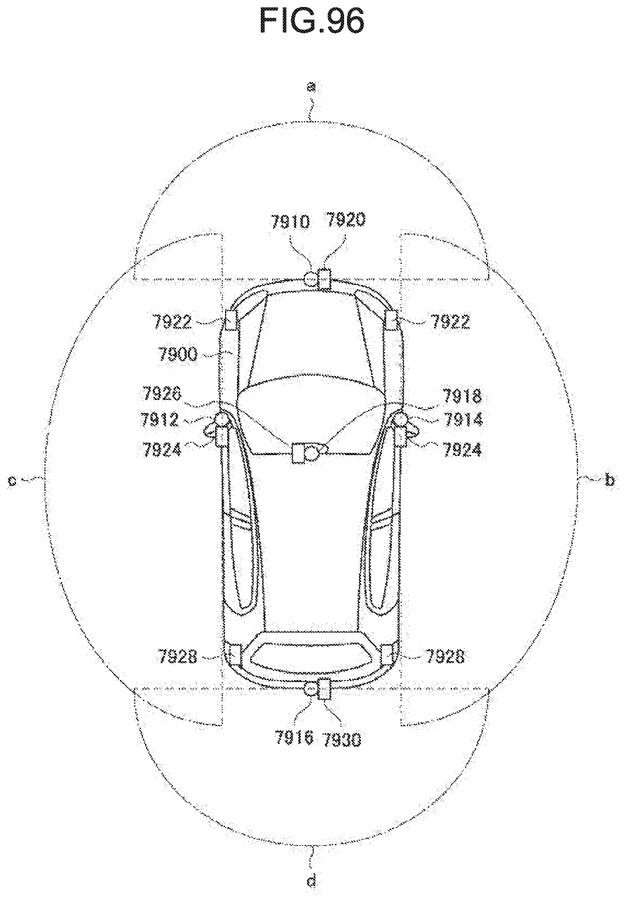

FIG. 96 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of a vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 96 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 95, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 95, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 95 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each of the functions of the sensor system 1 according to the embodiment described with reference to FIG. 1 can be implemented in any one of the control units or the like. It is also possible to provide a computer-readable recording medium storing such a computer program. The recording medium is, for example, a magnetic disk, an optical disk, a magneto-optical disk, a flash memory, or the like. Alternatively, the computer program described above may be distributed via, for example, a network without using a recording medium.

In the vehicle control system 7000 described above, the communication device 2 according to the embodiment described with reference to FIG. 2 can be applied to the integrated control unit 7600 of the application example illustrated in FIG. 95. For example, the main processor 14, the memory 15, and the transmission and reception section 20 of the communication device 2 correspond to the microcomputer 7610, the storage section 7690, and the vehicle-mounted network I/F 7680 of the integrated control unit 7600, respectively.

In addition, at least some components of the communication device 2 described with reference to FIG. 2 may be implemented in a module (for example, an integrated circuit module including one die) for the integrated control unit 7600 illustrated in FIG. 95. Furthermore, the sensor system 1 described with reference to FIG. 1 may be implemented by a plurality of control units of the vehicle control system 7000 illustrated in FIG. 95.

Although the embodiments of the present disclosure have been described above, the technical scope of the present disclosure is not limited to the above embodiments as they are, and various modifications can be made without departing from the gist of the present disclosure. In addition, components of different embodiments and modifications may be combined as required.

Furthermore, the effects of the embodiments described herein are merely examples and are not limiting, and other effects may be achieved.

Note that the present technology can also have the following configurations.

(1)

A ranging device comprising:

a sensor that acquires ranging information;

a field-programmable gate array (FPGA) that executes predetermined processing on the ranging information acquired by the sensor; and

a memory that stores data for causing the FPGA to execute the predetermined processing.

(2)

The ranging device according to (1), wherein the data in the memory is updated depending on an analysis result of the ranging information.

(3)

The ranging device according to (1) or (2), further comprising:

a transmission section that transmits the ranging information on which the predetermined processing has been executed to a predetermined network; and

a reception section that receives update data for updating the FPGA, the update data generated depending on an analysis result of the ranging information transmitted to the predetermined network,

wherein the data in the memory is updated with the update data.

(4)

The ranging device according to (3),

wherein the transmission section wirelessly transmits the ranging information to the predetermined network, and

the reception section wirelessly receives the update data from the predetermined network.

(5)

The ranging device according to (4), further comprising:

an encryption section that encrypts the ranging information; and

a decryption section that decrypts the update data.

(6)

The ranging device according to any one of (1) to (5), further comprising a processor that analyzes the ranging information, generates update data for updating the FPGA depending on a result of the analysis, and updates the data in the memory with the update data that has been generated.

(7)

The ranging device according to (6), further comprising

an analysis circuit that analyzes the ranging information by machine learning using at least one of a deep neural network (DNN) or a convolutional neural network (CNN),

wherein the processor analyzes the ranging information on a basis of a result of the machine learning by the analysis circuit.

(8)

The ranging device according to (6),

wherein the FPGA comprises an analysis circuit that analyzes the ranging information by machine learning using at least one of a deep neural network (DNN) or a convolutional neural network (CNN), and

the processor analyzes the ranging information on a basis of a result of the machine learning by the analysis circuit.

(9)

The ranging device according to any one of (1) to (5), further including:

an analysis circuit that analyzes the ranging information by machine learning using at least one of a deep neural network (DNN) or a convolutional neural network (CNN),

in which the data in the memory is updated on the basis of a result obtained by analyzing the ranging information on the basis of a result of the machine learning.

(10)

The ranging device according to any one of (1) to (5),

in which the FPGA includes an analysis circuit that analyzes the ranging information by machine learning using at least one of a deep neural network (DNN) or a convolutional neural network (CNN), and

the data in the memory is updated on the basis of a result obtained by analyzing the ranging information on the basis of a result of the machine learning.

(11)

The ranging device according to any one of (1) to (10), further comprising:

a transmission section that transmits the ranging information on which the predetermined processing has been executed to a predetermined network;

a reception section that receives update data for updating the FPGA, the update data generated depending on an analysis result of the ranging information transmitted to the predetermined network;

a processor that analyzes the ranging information and generates the update data for updating the FPGA depending on a result of the analysis; and

a switching section that switches between whether to transmit the ranging information to the predetermined network via the transmission section or to input the ranging information to the processor,

wherein the data in the memory is updated with the update data received by the reception section or the update data generated by the processor.

(12)

The ranging device according to any one of (1) to (11),

wherein the ranging information is ranging data, and

the sensor comprises a light receiving section comprising a plurality of photoelectric conversion elements and a signal processing circuit that reads the ranging data from the light receiving section.

(13)

The ranging device according to any one of (1) to (12), wherein the predetermined processing includes at least one of CDS, AD conversion, black level processing, phase component calculation, phase data processing, luminance data processing, cycle error correction, temperature correction, distortion correction, parallax correction, correction of a control system that controls the sensor, automatic exposure, automatic focus, flaw correction, noise correction, flying pixel correction, or depth calculation.

(14)

The ranging device according to any one of (1) to (13), wherein the data includes circuit data for incorporating a circuit configuration for executing the predetermined processing in the FPGA and setting data including a parameter to be set in the circuit configuration.

(15)

The ranging device according to any one of (1) to (14), further comprising a processor that executes the predetermined processing in cooperation with the FPGA.

(16)

The ranging device according to any one of (1) to (15), further comprising:

a first chip comprising the sensor;

a second chip comprising the FPGA; and

a third chip including the memory,

wherein the ranging device has a stack structure in which the first to third chips are stacked.

(17)

The ranging device according to (16), in which the third chip is located between the first chip and the second chip.

(18)

The ranging device according to (16) or (17), further including:

a fourth chip including a processor that executes the predetermined processing in cooperation with the FPGA,

in which the stack structure includes a structure in which the first to fourth chips are stacked.

(19)

The ranging device according to (18),

in which the first chip is located at an uppermost layer of the stack structure, and

the fourth chip is located at a lowermost layer of the stack structure.

(20)

The ranging device according to any one of (1) to (15), further comprising:

a first chip comprising the sensor; and

a second chip comprising the FPGA and the memory,

wherein the ranging device has a stack structure in which the first to second chips are stacked.

(21)

The ranging device according to (15), further comprising:

a first chip comprising the sensor; and

a second chip comprising the FPGA, the memory, and the processor,

wherein the ranging device has a stack structure in which the first to second chips are stacked.

(22)

The ranging device according to any one of (16) to (21),

wherein the ranging information is depth data,

the sensor comprises a light receiving section comprising a plurality of photoelectric conversion elements and a signal processing circuit that reads image data from the light receiving section, and

the first chip comprises a fifth chip comprising the light receiving section and a sixth chip comprising the signal processing circuit.

(23)

An electronic device comprising:

a sensor that acquires ranging information;

an FPGA that executes predetermined processing on the ranging information acquired by the sensor; and

a memory that stores data for causing the FPGA to execute the predetermined processing.

(24)

A sensor system in which an electronic device and a server are connected via a predetermined network,

wherein the electronic device comprises:

a sensor that acquires ranging information;

an FPGA that executes predetermined processing on the ranging information acquired by the sensor;

a memory that stores data for causing the FPGA to execute the predetermined processing;

a transmission section that transmits the ranging information on which the predetermined processing has been executed to a predetermined network; and

a reception section that receives update data for updating the FPGA, the update data generated depending on an analysis result of the ranging information transmitted to the predetermined network,

the server analyzes the ranging information received from the electronic device via the predetermined network, generates the update data for updating the FPGA depending on a result of the analysis, and transmits the update data that has been generated to the predetermined network, and

the data in the memory is updated with the update data received by the reception section via the predetermined network.

(25)

A control method comprising the steps of: analyzing ranging information acquired by a sensor; and changing at least one of a circuit configuration of an FPGA that executes predetermined processing on the ranging information or a setting value of the circuit configuration depending on an analysis result of the ranging information.

### REFERENCE SIGNS LIST

1 SENSOR SYSTEM
2 COMMUNICATION DEVICE
3 SERVER
4 NETWORK
10 SENSOR CHIP
11 LIGHT RECEIVING SECTION
12 SIGNAL PROCESSING CIRCUIT
13 FLEXIBLE LOGIC CIRCUIT
14 MAIN PROCESSOR
15 MEMORY
16 AF/OIS DRIVER
17 NON-VOLATILE MEMORY
18 LASER DRIVER
19 LIGHT EMITTING SECTION
20 TRANSMISSION AND RECEPTION SECTION
21 DAC
22 TRANSMISSION ANTENNA
23 ADC
24 RECEPTION ANTENNA
31, 51 ANALYSIS CIRCUIT
43 FLEXIBLE LOGIC CIRCUIT (ANALYSIS CIRCUIT)
100, 200, 300, 400 RANGING SENSOR
101 PHOTOELECTRIC CONVERSION
110 LIGHT RECEIVING CHIP
111 OPTICAL SENSOR ARRAY
120 ANALOG LOGIC CHIP
121 PIXEL CIRCUIT
122 ANALOG CIRCUIT
123 LOGIC CIRCUIT
130 FLEXIBLE LOGIC CHIP
131 FPGA
132 LOGIC CIRCUIT
140 PROCESSOR CHIP
141 MPU
150 MEMORY CHIP
151 MEMORY SPACE
152 PROGRAMMABLE MEMORY SPACE
160, T1 to T3 CHIP
201 A/D, CDS
301 PHASE COMPONENT CALCULATION (I, Q)
302 PHASE DATA PROCESSING
303 LUMINANCE DATA PROCESSING
401 CYCLE ERROR CORRECTION
402 TEMPERATURE CORRECTION
403 DISTORTION CORRECTION
404 PARALLAX CORRECTION
501 CONTROL SYSTEM CORRECTION
601 AE, AF
602 FLAW CORRECTION
603 NOISE CORRECTION (FILTER ADDITION)
604 FLYING PIXEL CORRECTION
605 DEPTH CALCULATION
606 OUTPUT I/F PROCESSING
S100 PHOTOELECTRIC CONVERSION STEP
S200 SIGNAL PROCESSING STEP
S300 PHASE CONVERSION STEP
S400 CALIBRATION STEP
S500 CONTROL SYSTEM STEP
S600 FILTERING STEP
S700 DNN/CNN ANALYSIS STEP

1. A ranging device comprising:
a sensor that acquires ranging information;
a field-programmable gate array (FPGA) that executes predetermined processing on the ranging information acquired by the sensor; and
a memory that stores data for causing the FPGA to execute the predetermined processing.

2. The ranging device according to claim 1, wherein the data in the memory is updated depending on an analysis result of the ranging information.

3. The ranging device according to claim 1, further comprising:
a transmission section that transmits the ranging information on which the predetermined processing has been executed to a predetermined network; and
a reception section that receives update data for updating the FPGA, the update data generated depending on an analysis result of the ranging information transmitted to the predetermined network,
wherein the data in the memory is updated with the update data.

4. The ranging device according to claim 3,
wherein the transmission section wirelessly transmits the ranging information to the predetermined network, and
the reception section wirelessly receives the update data from the predetermined network.

5. The ranging device according to claim 4, further comprising:
an encryption section that encrypts the ranging information; and
a decryption section that decrypts the update data.

6. The ranging device according to claim 1, further comprising a processor that analyzes the ranging information, generates update data for updating the FPGA depending on a result of the analysis, and updates the data in the memory with the update data that has been generated.

7. The ranging device according to claim 6, further comprising
an analysis circuit that analyzes the ranging information by machine learning using at least one of a deep neural network (DNN) or a convolutional neural network (CNN),
wherein the processor analyzes the ranging information on a basis of a result of the machine learning by the analysis circuit.

8. The ranging device according to claim 6,
wherein the FPGA comprises an analysis circuit that analyzes the ranging information by machine learning using at least one of a deep neural network (DNN) or a convolutional neural network (CNN), and
the processor analyzes the ranging information on a basis of a result of the machine learning by the analysis circuit.

9. The ranging device according to claim 1, further comprising:
a transmission section that transmits the ranging information on which the predetermined processing has been executed to a predetermined network;
a reception section that receives update data for updating the FPGA, the update data generated depending on an analysis result of the ranging information transmitted to the predetermined network;
a processor that analyzes the ranging information and generates the update data for updating the FPGA depending on a result of the analysis; and
a switching section that switches between whether to transmit the ranging information to the predetermined network via the transmission section or to input the ranging information to the processor,
wherein the data in the memory is updated with the update data received by the reception section or the update data generated by the processor.

10. The ranging device according to claim 1,
wherein the ranging information is ranging data, and
the sensor comprises a light receiving section comprising a plurality of photoelectric conversion elements and a signal processing circuit that reads the ranging data from the light receiving section.

11. The ranging device according to claim 1, wherein the predetermined processing includes at least one of CDS, AD conversion, black level processing, phase component calculation, phase data processing, luminance data processing, cycle error correction, temperature correction, distortion correction, parallax correction, correction of a control system that controls the sensor, automatic exposure, automatic focus, flaw correction, noise correction, flying pixel correction, or depth calculation.

12. The ranging device according to claim 1, wherein the data includes circuit data for incorporating a circuit configuration for executing the predetermined processing in the FPGA and setting data including a parameter to be set in the circuit configuration.

13. The ranging device according to claim 1, further comprising a processor that executes the predetermined processing in cooperation with the FPGA.

14. The ranging device according to claim 1, further comprising:
a first chip comprising the sensor;
a second chip comprising the FPGA; and
a third chip including the memory,
wherein the ranging device has a stack structure in which the first to third chips are stacked.

15. The ranging device according to claim 1, further comprising:
a first chip comprising the sensor; and
a second chip comprising the FPGA and the memory,
wherein the ranging device has a stack structure in which the first to second chips are stacked.

16. The ranging device according to claim 13, further comprising:
a first chip comprising the sensor; and
a second chip comprising the FPGA, the memory, and the processor,
wherein the ranging device has a stack structure in which the first to second chips are stacked.

17. The ranging device according to claim 14,
wherein the ranging information is depth data,
the sensor comprises a light receiving section comprising a plurality of photoelectric conversion elements and a signal processing circuit that reads image data from the light receiving section, and
the first chip comprises a fifth chip comprising the light receiving section and a sixth chip comprising the signal processing circuit.

18. An electronic device comprising:
a sensor that acquires ranging information;
an FPGA that executes predetermined processing on the ranging information acquired by the sensor; and
a memory that stores data for causing the FPGA to execute the predetermined processing.

19. A sensor system in which an electronic device and a server are connected via a predetermined network,
wherein the electronic device comprises:
a sensor that acquires ranging information;
an FPGA that executes predetermined processing on the ranging information acquired by the sensor;
a memory that stores data for causing the FPGA to execute the predetermined processing;
a transmission section that transmits the ranging information on which the predetermined processing has been executed to a predetermined network; and
a reception section that receives update data for updating the FPGA, the update data generated depending on an analysis result of the ranging information transmitted to the predetermined network,
the server analyzes the ranging information received from the electronic device via the predetermined network, generates the update data for updating the FPGA depending on a result of the analysis, and transmits the update data that has been generated to the predetermined network, and
the data in the memory is updated with the update data received by the reception section via the predetermined network.

20. A control method comprising the steps of:
analyzing ranging information acquired by a sensor; and
changing at least one of a circuit configuration of an FPGA that executes predetermined processing on the ranging information or a setting value of the circuit configuration depending on an analysis result of the ranging information.
